(19) United States
(12) Patent Application Publication
(10) Pub. No.: US 2011/0128557 A1
(43) Pub. Date: Jun. 2, 2011

(54) TABLET PRINTING APPARATUS AND TABLET PRODUCTION METHOD, AND TABLET

(75) Inventors: Noriyuki Kinoshita, Chuo-ku (JP); Takao Mizumoto, Chuo-ku (JP); Keizo Baba, Chuo-ku (JP); Takashi Nishizato, Chuo-ku (JP); Syuya Kawahama, Chuo-ku (JP); Hideyuki Tomoda, Chuo-ku (JP); Yoshihide Muramatsu, Yaizu-shi (JP); Shiro Hatano, Chiyoda-ku (JP); Fumihiro Ogawa, Hirakata-shi (JP); Chizuo Ozawa, Shiojiri-shi (JP)

(73) Assignees: ASTELLAS PHARMA INC., Chuo-ku, Tokyo (JP); DAIICHI JITSUGYO CO., LTD., Chiyoda-ku, Tokyo (JP); DAIICHI JITSUGYO VISWILL CO., LTD., Suita-City, Osaka (JP); MASTERMIND CO., LTD., Shiojiri-shi, Nagano (JP)

(21) Appl. No.: 12/674,650

(22) PCT Filed: Aug. 22, 2008
(86) PCT No.: PCT/JP2008/065046

§ 371 Date: Jun. 18, 2010

(30) Foreign Application Priority Data
Aug. 22, 2007 (JP) 2007-215994

(51) Int. Cl. G06K 15/16; H04N 1/60; G06K 15/02

(52) U.S. Cl. 358/1.5; 358/1.12; 358/1.9

(57) ABSTRACT

There is provided a tablet printing apparatus that can perform printing at a high speed on tablets arbitrarily supplied in volume at irregular intervals and has a high printing quality. A tablet printing apparatus 1 for multicolor printing on tablets T comprises a conveying belt 24 for conveying the tablets T in a moving direction A1-A2, an inkjet printer 42 disposed in the middle of the moving direction A1-A2 of the conveying belt 24 for performing non-contact printing onto surfaces of the tablets T conveyed by the conveying belt 24, an encoder 28 and a tablet sensor 29 for detecting moving positions of the tablets T conveyed by the conveying belt 24, and a unit control substrate 32 for controlling printing timing on the tablets T of the inject printer 42 or 46 based on the moving conditions or/and the moving positions of the tablets T detected by the encoder 28 and the tablet sensor 29. The conveying bet 24 conveys the tablets T in the moving direction A1-A2 in a state that they are irregularly adsorbed and held.

### TECHNICAL FIELD

The present invention relates to a tablet printing apparatus and a tablet production method, and a tablet, and more particularly to a tablet printing apparatus and a tablet production method for printing on tablets, and a tablet subjected to printing.

### BACKGROUND ART

In hospitals or pharmacies, one-dose preparation of two or more types of tablets may be made for patients who take a plurality of types of tablets at the same time. In general, identifying information such as a product name is indicated on a surface of a tablet, and a pharmacist takes out tablets from a PTP (Press Through Package), then identifies types of the tablets while confirming identifying information indicated on a surface of each tablet, and packages necessary tablets alone by using tablet packaging paper. Therefore, tablets that can be readily discriminated from other tablets even after taking out the tablets from the PTP have been demanded. Likewise, a patient side has also demanded facilitation of discriminating tablets by themselves since improper dose can be avoided if tablets can be easily discriminated even after the tablets are taken out from the PTP.

As a method for indicating identifying information on a surface of each tablet, marking using a forming die in forming based on, e.g., tableting or printing using offset printing has been conventionally carried out.

In indication based on marking, however, since identifying information is indicated by shading formed by a small concavo-convex shape on a tablet surface, the identifying information is unclear, and identifying the tablet is difficult. Therefore, a medical error due to occurrence of erroneous packaging of tablets may possibly arise.

On the other hand, in printing on a tablet surface based on, e.g., offset printing, identifying information indicated on the tablet surface can be made clear by performing printing with an ink different from a color tone of a tablet. Therefore, the discrimination of the tablet alone can be improved as compared with the above-described marking, whereby a medical error due to improper dosing of medicines hardly occurs.

Since the offset printing is carried out in a contact scheme that an intermediate transcript is pressed against a tablet to print identifying information, the identifying information can be clearly printed on a coating tablet having a film-coated tablet surface. However, in a core tablet just formed without a coated film, printed identifying information partially suffers a loss or the like due to, e.g., a powder that has adhered to the surface, and clear printing is difficult. Further, in printing based on the contact scheme, a powder on the surface of the core tablet attaches to the intermediate transcript, clogging of the identifying information engraved on a print surface occurs, which may result in a printing error.

Furthermore, a core tablet, especially a fast-disintegrating tablet (e.g., an orally-disintegrating tablet) formed without being tableted or formed with a small tableting pressure has low tablet hardness and easily disintegrates under a pressure from the outside, whereby the tablet may possibly disintegrate under a pressure when pressing the intermediate transcript.

Therefore, a printing technology for tablets based on a non-contact scheme has been previously studied/developed.

As such a non-contact printing technology, a technology for discharging an ink to a surface of a tablet by using an inkjet printer to print identifying information on the surface of the tablet has been conventionally proposed (see, e.g., Patent Documents 1 to 3). Further, although a specific method is not disclosed, a method for marking on a surface of a tablet having a non-compressed porous reticulated structure by using an inkjet printer has been also proposed (see Patent Document 2).

According to the technologies disclosed in these documents, printing identifying information such as a product name on a tablet surface by discharging an edible ink from an inkjet printer is disclosed. When the tablet printing can be performed by the inkjet printer in a non-contact manner as described above, limiting an influence of a powder that has adhered to the tablet surface to enable clear printing is expected as compared with the conventional offset printing.

In particular, the technology disclosed in Patent Document 1 proposes supplying many tablets to a feed conveyor from a tablet moving board, mounting the tablets on this feed conveyor in a linearly aligned state, detecting a flow of the tablets by using a sensor, and discharging an ink at a timing that the tablets passes a position near inject nozzles to perform printing on the tablets.

Furthermore, according to the technology proposed in Patent Document 1, the tablets supplied from the tablet moving board do not have to be aligned on the feed conveyor at fixed intervals, the tablets are conveyed at a irregular intervals at a timing of supplying the tablets from the tablet moving board and detected by the sensor even though the tablets are irregularly aligned, and an ink discharge timing is controlled, thereby assuredly printing on the tablets with the ink.

In this manner, randomly mounting the tablets on the feed conveyor to be carried and immediately carrying the tablets without producing a tablet movement standby period when supplying the tablets from the tablet moving board to the feed conveyor is proposed.

Moreover, the technology in FIG. 5 disclosed in Patent Document 1 proposes sucking tablets from an air path in a concave portion of a rotary drum, emitting an ink from jet nozzles to perform printing on the tablets, providing concave portions aligned in a plurality of columns as shown in FIG. 6, and aligning the jet nozzles in parallel in accordance with the concave portions to enable printing.
Patent Document 1: Japanese Patent Application Laid-open No. 1995-81050 (claim 1, claim 4, paragraphs 0021 to 0022 and 0031 to 0034, FIGS. 2, 3, 5, and 6)
Patent Document 2: PCT National Publication No. 2000-512303 (claim 2, p. 9)
Patent Document 3: Japanese Patent Application Laid-open No. 1983-1768 (claim 1)

### DISCLOSURE OF INVENTION

### Problem to be Solved by the Invention

However, even if each of the proposed technologies is used, printing on tablets cannot be actually performed. It is considered that realizing contents of the proposed technology disclosed in each document is difficult.

That is, the printing technology disclosed in Patent Document 1 has a technical problem that displacement of a tablet occurs when the feed conveyor is moved at a high speed since the tablet is simply mounted on the feed conveyor, and hence carrying the tablet at a high speed is difficult. Although depending on conditions such as a shape of each tablet, in general, when a speed of the feed conveyor reaches 100 mm/second or above, most tablets are bounced or displaced on the feed conveyor during carriage. When such tablets are subjected to inkjet printing, a printing position deviates, or printed identifying information becomes unclear.

Additionally, considering the displacement and others, the proposed technology shown in FIGS. 5 and 6 of Patent Document 1 uses the rotary drum, and a technology for holding tablets in the concave portion previously formed in the rotary drum is proposed. However, according to the technology for holding the tablets in the concave portion formed in this rotary drum, the tablets carried in an irregular state must be previously aligned so that they can regularly enter the concave portion in the rotary drum. It is, therefore, difficult to cope with many tablets in many irregular carriage states, and the technology shown in FIGS. 5 and 6 of Patent Document 1 for performing many types of printing at the same time cannot be applied in irregular carriage states such as depicted in FIGS. 2 and 3 of Patent Document 1.

As explained above, in the conventional technologies, carrying tablets at a high speed to be subjected to printing when the tablets are aligned at irregular intervals is difficult when carrying out printing on the tablets. In short, when actually performing non-contact printing with respect to tablets, the tablets that are carried at a high speed and aligned at irregular intervals cannot be subjected printing using the inkjet printer at a high speed.

It is an object of the present invention to provide a tablet printing apparatus and a tablet production method that can perform printing at a high speed on tablets that are aligned at irregular intervals and arbitrarily supplied in high volumes and that have a high printing quality.

It is another object of the present invention to provide a novel tablet preferable as a tablet, a core tablet, and an orally-disintegrating tablet printed with inks having one or more colors. It is still another object of the present invention to provide a new tablet subjected to clear printing even though it is a core tablet, especially an orally-disintegrating tablet.

### Means for Solving Problem

The above-described objects can be achieved by a tablet printing apparatus according to the present invention comprising: tablet conveying means that has a case body having an opening at an upper portion thereof, a slit plate arranged on the opening of the case body, a conveying path including a conveying belt that has a slit communicating with the inside of the case body formed between belts arranged in parallel along a slit of the slit plate and that conveys tablets, driving means for moving the conveying belt constituting the conveying path, and negative pressure means for forming a negative pressure in the case body, and that conveys the tablets in a moving direction in a state where the tablets are sucked and held on the conveying belt through both the slits by the negative pressure in the case body; position detecting means for detecting positions of the tablets conveyed by the tablet conveying means on the conveying belt by using a tablet sensor that detects the tablets and an encoder that detects a moving state of the conveying belt irrespective of a moving speed of the conveying belt; printing means for performing printing on the tablets conveyed by the tablet conveying means in a non-contact manner by using a plurality of printer heads that are arranged in parallel and fixed with respect to the tablet conveying means along a perpendicular direction of the moving direction of the tablets and have a plurality of nozzle holes for discharging inks being aligned in series at a slat with respect to the moving direction of the tablets; and printing controlling means for controlling printing on the tablets performed by the printing means based on positions of the tablets on the conveying belt detected by the position detecting means.

As explained above, according to the tablet printing apparatus of the present invention, since the printing means for performing printing on the tablet in the non-contact manner is provided, a hiatus of printing or the like is hardly produced and clear printing can be effected even on a tablet (e.g., a core tablet) having a powder adhered to a surface thereof as compared with conventional contact offset printing. Further, since the plurality of printer heads are provided, a large amount of printing can be carried out at a high speed.

Furthermore, according to the tablet printing apparatus of the present invention, since the tablet can be conveyed while being adsorbed and held, the tablet can be conveyed at a high speed in a state that displacement of the tablet hardly occurs. Therefore, clear printing without distortion can be performed at a fixed position on the tablet surface without causing displacement or the like at a printing position provided by the printing means. That is, since the tablet is sucked and held through the slit of the conveying belt, displacement, dropping, and others of the tablet hardly occurs with respect to the conveying belt. Therefore, the tablet can be conveyed at a high speed, and accurate printing can be effected.

Moreover, there is adopted the line head scheme that the printer heads are arranged and fixed in parallel along a perpendicular direction of a moving direction with respect to the tablet conveying means and they are arranged in parallel along a perpendicular direction of a moving direction of the tablet, the heads do not have to be moved as different from a serial head scheme, and a speed of print processing can be increased.

Additionally, since the plurality of printer heads are arranged in parallel along the perpendicular direction of the moving direction of the tablet, appropriately increasing or decreasing the number of arranged printer heads enables performing printing with a desired width.

Further, since the plurality of nozzle holes for discharging inks are aligned at a slant with respect to the moving direction of the tablet, the number of the nozzle holes in the perpendicular direction of the moving direction can be increased, thereby improving a printing resolution.

When the tablet sensor senses the tablet and the encoder detects a moving position of the tablet conveying means, a position detected by the tablet sensor is determined as a reference, and a current moving position of the tablet can be acquired. Therefore, even if a speed of the tablet conveying means changes, a moving state or a position of the tablet can be accurately acquired, and the printing means is used for executing printing control based on a position of the tablet on the conveying belt detected by the position detecting means, thereby assuredly effecting printing on the tablet.

Furthermore, it is preferable that the printing controlling means includes an image data memory that stores a master image to be printed on the tablets, a buffer memory that temporarily stores the master image, a write controller that writes the master image into the buffer memory, and a read controller that reads out the master image stored in the buffer memory, the write controller writes the master image into the buffer memory at a timing that the tablets are detected by the tablet sensor, the buffer memory shifts an address at which the master image is stored in the buffer memory in synchronization with a pulse signal from the encoder, and the read controller reads out the master image and outputs it for printing when the master image is stored at a predetermined read address.

As explained above, the write controller temporarily stores a master image in the buffer memory at a timing that the tablets are detected by the tablet sensor and shifts an address in the buffer memory at which the master image is stored in synchronization with a pulse signal from the encoder, and the read controller reads the master image and outputs it for printing when the master image is stored at a predetermined read address, whereby an actual moving position of the tablet can be acquired based on a moving position of the tablet conveying means while the position detected by the tablet sensor being determined as a reference.

Therefore, even if a speed of the tablet conveying means changes, a position of the tablet can be accurately acquired, and printing on the tablet can be assuredly effected based on this position.

Moreover, it is preferable that the tablet conveying means has a plurality of conveying paths along which the tablets are conveyed, the position detecting means detects moving positions of the tablets in the plurality of respective conveying paths, and the printing controlling means controls a print timing provided by the printing means based on the moving positions of the tablets detected in the plurality of respective conveying paths by the position detecting means.

As explained above, when the plurality of conveying paths are provided, the plurality of tablets can be simultaneously conveyed in the different conveying paths, and printing can be effected. As a result, a throughput for tablet printing can be improved as compared with a case where the tablets are conveyed through a single conveying path.

It is preferable that a plurality of nozzle hole groups including the plurality of nozzle holes are formed in the printer heads, and the plurality of nozzle hole groups discharge inks having different colors to enable printing in at least two colors. As a result, polychromic printing can be carried out by discharging from one printer head the inks having colors that differ depending on each nozzle group.

Additionally, the tablet can be preferably applied to a core tablet, especially an orally-disintegrating tablet. In general, since the core tablet, especially the orally-disintegrating tablet has a large amount of powder on a surface thereof and it is formed with porosity, printing is difficult but, according to the tablet printing apparatus of the present invention, printing can be carried out with respect to such a core tablet, especially the orally-disintegrating tablet.

In the tablet printing apparatus according to the present invention, the conveying belt can be applied to one that moves at a speed in the range of 500 mm/second to 2000 mm/second. Even if a regular speed is changed to a high speed in this manner, printing appropriate for a moving speed of the conveying belt can be performed by the tablet conveying means, the position detecting means, the printing means, and the printing controlling means as constituent elements of the present invention.

The objects can be achieved by a tablet printing apparatus according to claim 7 comprising: tablet conveying means that has a case body having an opening at an upper portion thereof, a slit plate arranged on the opening of the case body, a conveying path including a conveying belt that has a slit communicating with the inside of the case body formed between belts arranged in parallel along a slit of the slit plate and that conveys tablets, driving means for moving the conveying belt constituting the conveying path, and negative pressure means for forming a negative pressure in the case body, and that conveys the tablets in a moving direction in a state where the tablets are sucked and held on the conveying belt through both the slits by a negative pressure in the case body; position detecting means for detecting positions of the tablets conveyed by the tablet conveying means on the conveying belt by using a tablet sensor that detects the tablets and an encoder that detects a moving state of the conveying belt irrespective of a moving speed of the conveying belt; printing means for performing printing on the tablets conveyed by the tablet conveying means in a non-contact manner by constituting each printer unit by using a plurality of printer heads that are arranged in parallel and fixed with respect to the tablet conveying means along a perpendicular direction of the moving direction of the tablets and have a plurality of nozzle holes for discharging inks being aligned in series at a slant with respect to the moving direction of the tablets and by providing the plurality of printer units at different positions along the moving direction of the tablets to discharge inks having different colors from the printer units; and printing controlling means for controlling printing on the tablets performed by the printing means based on positions of the tablets on the conveying belt detected by the position detecting means.

The printer unit is formed of the plurality of printer heads as the printing means, the plurality of printer units are provided at different positions along the moving direction of the tablet, and the respective printer units discharge the inks of different colors to perform non-contact printing on the tablet conveyed by the tablet conveying means, thus discharging the inks of colors that differ depending on an upstream side and a downstream side of the moving direction.

Therefore, when performing polychromic printing by using, e.g., a single printer unit, ink discharge actuators or nozzle holes of this printer unit must be highly integrated, but arranging the plurality of units at different positions along the moving direction of the tablet like the present invention enables effecting polychromic printing at a high resolution with a simple structure without highly integrating the ink discharge actuators and others.

When printing with two or more types of color inks in particular, a variation of printing colors can be increased as compared with single-color printing. Further, when the plurality of units are used for polychromic printing, a clear color image can be printed on the tablet at a high speed.

According to a tablet production method of the present invention, the objects can be achieved by performing printing on many tablets irregularly conveyed by a conveying belt, the method comprising: a tablet forming step of forming each tablet into a predetermined shape; a tablet conveying step of conveying the tablets in a state where the formed tablets are held on the conveying belt; a position detecting step of detecting positions of the tablets conveyed at the tablet conveying step on the conveying belt by using a tablet sensor that detects the tablets and an encoder that detects a moving state of the conveying belt irrespective of a moving speed of the conveying belt; a printing controlling step of controlling printing on the tablets based on positions of the tablets on the conveying belt detected at the position detecting step; and a printing step of performing printing on the tablets conveyed at the tablet conveying step in a non-contact manner by using a plurality of printer heads that are arranged in parallel and fixed along a perpendicular direction of the moving direction of the conveying belt and have a plurality of nozzle holes for discharging inks being aligned in series at a slant with respect to the moving direction of the tablet conveying belt.

As explained above, the tablet forming step, the tablet conveying step, the position detecting step, the printing controlling step, and the printing step enable printing on a large quantity of tablets irregularly conveyed at a high speed.

The objects can be achieved by a tablet according to the present invention subjected to printing by a tablet printing apparatus, the apparatus comprising: a tablet formed into a predetermined shape; tablet conveying means that has: a case body having an opening at an upper portion thereof; a slit plate arranged on the opening of the case body; a conveying path including a conveying belt that has a slit communicating with the inside of the case body formed between belts arranged in parallel along a slit of the slit plate and that conveys the tablets; driving means for moving the conveying belt constituting the conveying path; and negative pressure means for forming a negative pressure in the case body, and that conveys the tablets in a moving direction in a state where the tablets are sucked and held on the conveying belt through both the slits by a negative pressure in the case body; position detecting means for detecting positions of the tablets conveyed by the tablet conveying means on the conveying belt by using a tablet sensor that detects the conveyed tablets and an encoder that detects a moving state of the conveying belt irrespective of a moving speed of the conveying belt; printing means for performing printing on the tablets conveyed by the tablet conveying means in a non-contact manner by using a plurality of printer heads that are arranged in parallel and fixed with respect to the tablet conveying means along a perpendicular direction of the moving direction of the tablets and have a plurality of nozzle holes for discharging inks being aligned in series at a slant with respect to the moving direction of the tablets; and printing controlling means for controlling printing on the tablets performed by the printing means based on positions of the tablets on the conveying belt detected by the position detecting means.

Furthermore, the objects can be achieved by a tablet according to the present invention subjected to printing based on a tablet printing method for performing printing on many tablets irregularly conveyed by a conveying belt, the method comprising: a tablet forming step of forming each tablet into a predetermined shape; a tablet conveying step of conveying the tablets in a state where the formed tablets are held on the conveying belt; a position detecting step of detecting positions of the tablets conveyed at the tablet conveying step on the conveying belt by using a tablet sensor that detects the tablets and an encoder that detects a moving state of the conveying belt irrespective of a moving speed of the conveying belt; a printing controlling step of controlling printing on the tablets based on positions of the tablets on the conveying belt detected at the position detecting step; and a printing step of performing printing on the tablets conveyed at the tablet conveying step in a non-contact manner by using a plurality of printer heads that are arranged in parallel and fixed along a perpendicular direction of the moving direction of the conveying belt and have a plurality of nozzle holes for discharging inks being aligned in series at a slant with respect to the moving direction of the tablet conveying belt.

As described above, the tablet subjected to printing can be obtained by the tablet printing apparatus or the tablet production method. Moreover, a core tablet can be used as the tablet, and this core tablet can be subjected to printing to obtain the tablet.

According to the tablet of the present invention, the objects can be achieved by performing printing on a core tablet by using one or more types of color inks. In this manner, a novel tablet obtained by printing on the core tablet with one or more types color inks can be provided.

Additionally, it is preferable for the ink colors to be one or more colors selected from a group including yellow, magenta, cyan, and black. When identifying information is printed by using the inks having one or more colors selected from the group including these four colors, an unprecedented novel tablet obtained by printing a clear color image on a tablet can be provided.

At this time, it is preferable for a void ratio of the core tablet to fall within the range of 5% to 40%. As explained above, when the void ratio is lower than 40%, the porosity of the tablet is not too high, bleeding of the ink caused by infiltration of the ink into pores hardly occurs, and the tablet having clear identifying information can be provided. Further, the range of 5% to 35% is another conformation of the preferable void ratio, and the range of 5% to 30% is still another conformation of the same.

It is to be noted that the “void ratio” means a void ratio obtained by the following expression. This can be applied to other descriptions in this specification.

$$Void ratio = \frac{V - ( W / ρ )}{V} \times 100 \qquad [ Expression 1 ]$$

(where V; a volume of a tablet, W; a weight of the tablet, and p; a specific gravity of a powder constituting the tablet.)

In this case, it is preferable for the core tablet to be obtained by performing compression forming with respect to a raw material containing active substances. Since the tablet is the core tablet subjected to compression forming in this manner, bleeding of identifying information printed on the surface hardly occurs as compared with a non-compressed core tablet, thereby providing the tablet having clear identifying information.

Furthermore, it is preferable for the core tablet to be an orally-disintegrating tablet. In general, since the orally-disintegrating tablet has a large amount of a powder on a surface thereof and it is porous, printing is difficult, but an unprecedented novel tablet obtained by performing printing on such an orally-disintegrating tablet can be provided according to the present invention.

### Effect of the Invention

According to the tablet printing apparatus and the tablet production method of the present invention, since non-contact printing can be effected on a tablet, clear printing can be performed with respect to even a tablet having a powder having adhered to a surface thereof (e.g., a core tablet) without a hiatus of printing and others. Moreover, since the plurality of printer heads are provided, voluminous printing can be carried out at a high speed, thereby reducing a print processing time.

Additionally, since each tablet can be conveyed in a adsorbed and held state, the tablet can be conveyed at a high speed while displacement of the tablet hardly occurs. Accordingly, printing can be accurately effected at a fixed position on a tablet surface without deviation or the like of a printing position provided by the printing means, and clear printing without distortion can be carried out. Therefore, the tablet is conveyed at a high speed to increase the number of times of print processing per unit time, and pattern misalignment hardly occurs even though such high-speed conveyance is performed, thereby sufficiently assuring a printing quality.

Therefore, increasing a speed of print processing with respect to a large quantity of tablets arbitrarily supplied at irregular intervals and assuring a printing quality can be both achieved.

Further, according to the tablet of the present invention, an unprecedented novel tablet obtained by performing printing on a core tablet, especially an orally-disintegrating tablet with one or more types of color inks can be provided. Furthermore, as a core tablet, especially an orally-disintegrating tablet with a void ratio of 5% to 40% obtained by compression forming, a tablet subjected to clear printing can be provided.

### BRIEF DESCRIPTION OF DRAWINGS

FIG. 1 is a perspective view showing an entire configuration of a tablet printing apparatus;

FIG. 2 is a schematic view showing an entire configuration of the tablet printing apparatus;

FIG. 3 is a cross-sectional view showing conveying means in a direction vertical to a tablet moving direction;

FIG. 4 is a functional block diagram of a printer head control substrate and peripheral devices;

FIG. 5 is explanatory views of the printer head;

FIG. 6 is a functional block diagram showing an outline of print processing with respect tablets performed by the tablet printing apparatus;

FIG. 7 is a functional block diagram showing an outline of print processing with respect to tablets performed by the tablet printing apparatus;

FIG. 8 is a functional block diagram showing an outline of print processing with respect to tablets performed by the tablet printing apparatus;

FIG. 9 is a functional block diagram showing an outline of print processing with respect to tablets performed by the tablet printing apparatus;

FIG. 10 is a functional block diagram showing an outline of print processing with respect to tablets performed by the tablet printing apparatus;

FIG. 11 is a functional block diagram showing an outline of print processing with respect to tablets performed by a tablet printing apparatus according to another embodiment;

FIG. 12 is a block diagram showing steps in a tablet production method; and

FIGS. 13(a) to (e) are photographs each obtained by shooting an entire tablet after printing characters on the tablet.

### EXPLANATIONS OF LETTERS OR NUMERALS

1 tablet printing apparatus
3 housing
3a intermediate plate
3b side plate
3c top panel
3d opening
10 supplying means
11 supply hopper
12 vibrating feeder
13 rectifying turntable
20 tablet conveying means
20a slit
21 case body
21a protruding portion
22a, 22b slit plate
24 conveying belt
24a, 24b belt
25 motor
26 pulley
27 suction pump
28 encoder (position detecting means)
29 tablet sensor (position detecting means)
30 printing controlling means
31 control computer (printing controlling means)
32 unit control substrate (printing controlling means)
   32a image data memory
   32b timing generation controller
   32c buffer memory
   32d write controller
   32e first read controller
   32f second read controller
   40 printing means
   41 ink tank
   42 inkjet printer
   43 printer head
   43a nozzle hole
   43b nozzle hole column group
   43b-1 to 43b-3 yellow nozzle hole column
   43c nozzle hole column group
   43c-1, 43c-2 magenta nozzle hole column
   44 printer head control substrate
   44a storage section
   44b color converting section
   44c head output section
   45 sub-tank
   46 inkjet printer
   47 printer head
   48 printer head control substrate
   48a storage section
   48b color converting section
   48c head output section
   49 sub-tank
   50 examining means
   51 printing section examination unit
   52 quality judgment unit
   128 encoder
   124a to 124c belt
   129a to 129c tablet sensor
   132 unit control substrate
   132a image data memory
   132b timing generation controller
   132c buffer memory
   132d write controller
   132e first read controller
   132f second read controller
   142 inkjet printer
   134 printer head
   144 printer head control substrate
   146 inkjet printer
   147 printer head
   148 printer head control substrate
   T tablet
   M, M1 to M3 master image
   A1-A2 moving direction
   ST start address
   RD1 first read address
   RD2 second read address
   END end address

### BEST MODE(S) FOR CARRYING OUT THE INVENTION

An embodiment according to the present invention will now be described hereinafter with reference to the drawings.

It is to be noted that members, arrangements, and others described below do not limit the present invention, and they can be of course modified in many ways in adherence with the spirit of the present invention. A tablet printing apparatus according to the present invention will now be described hereinafter in detail.

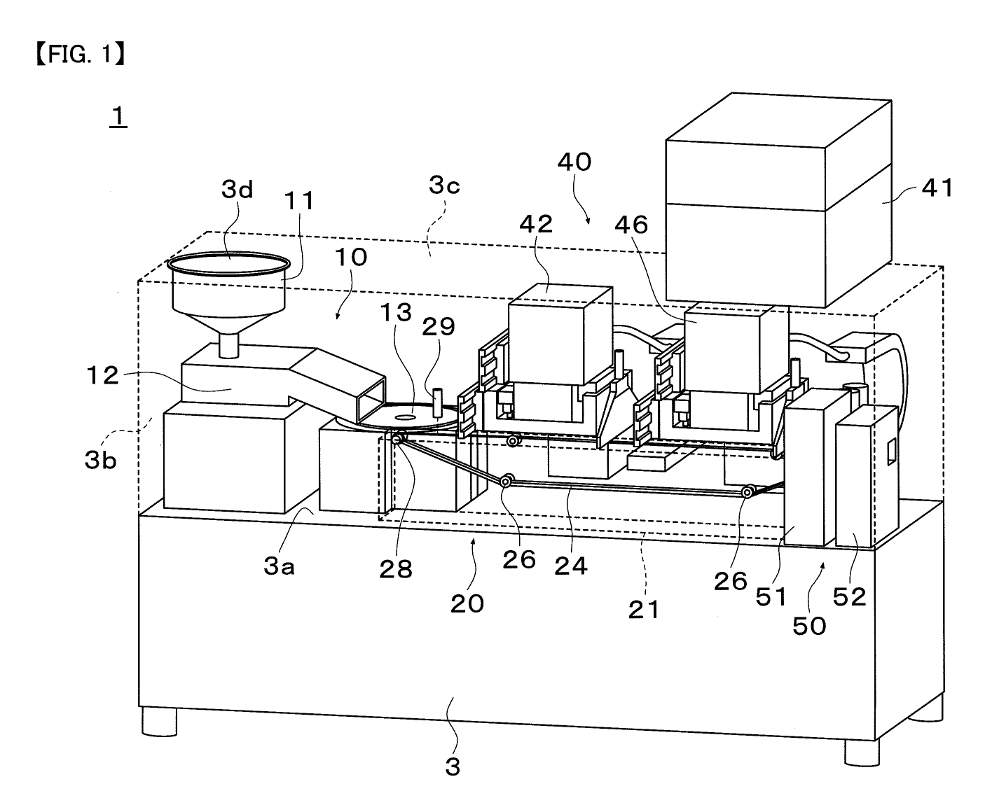

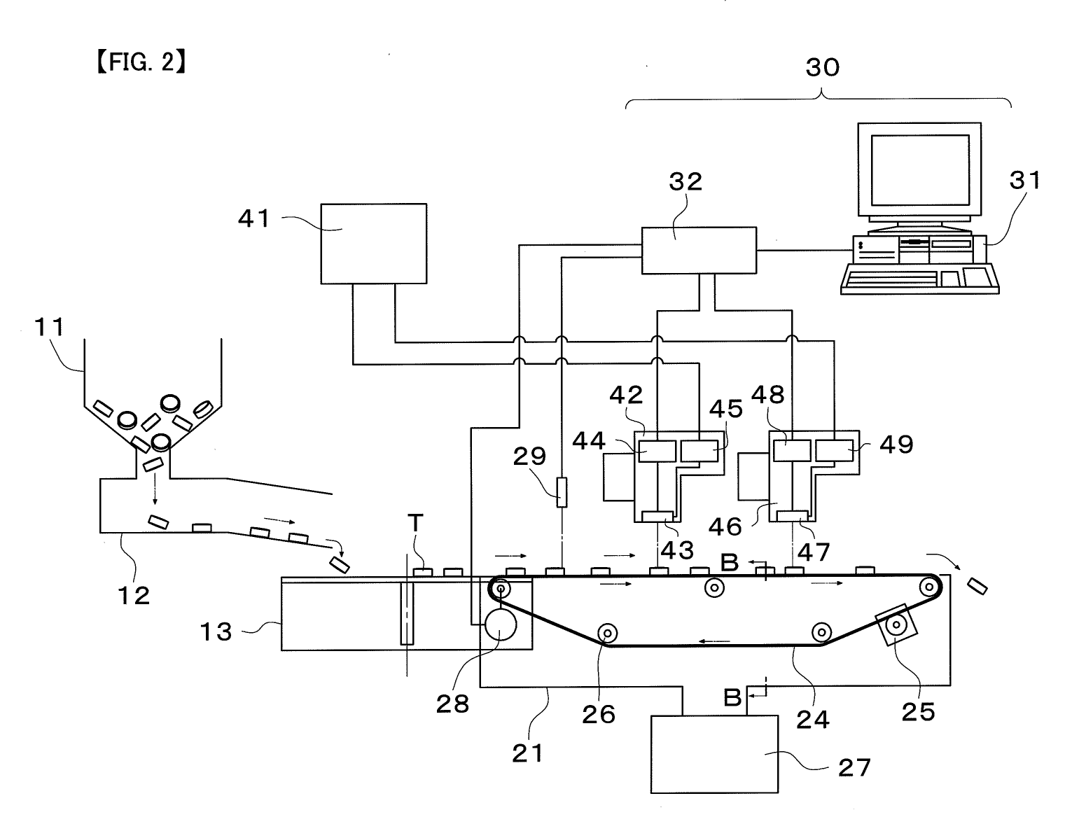

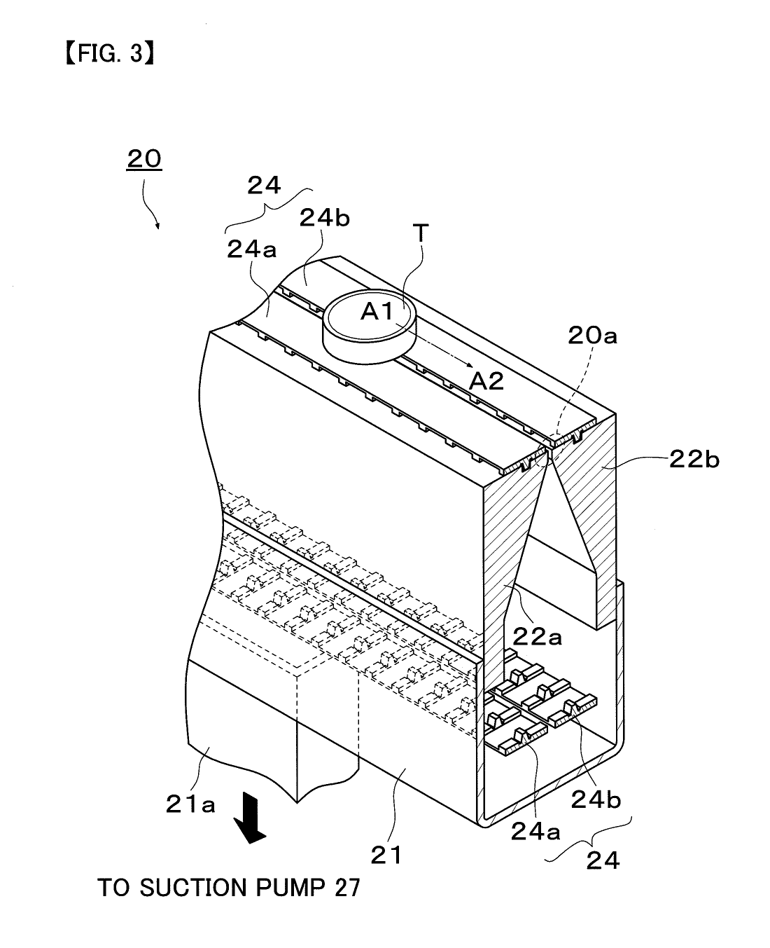

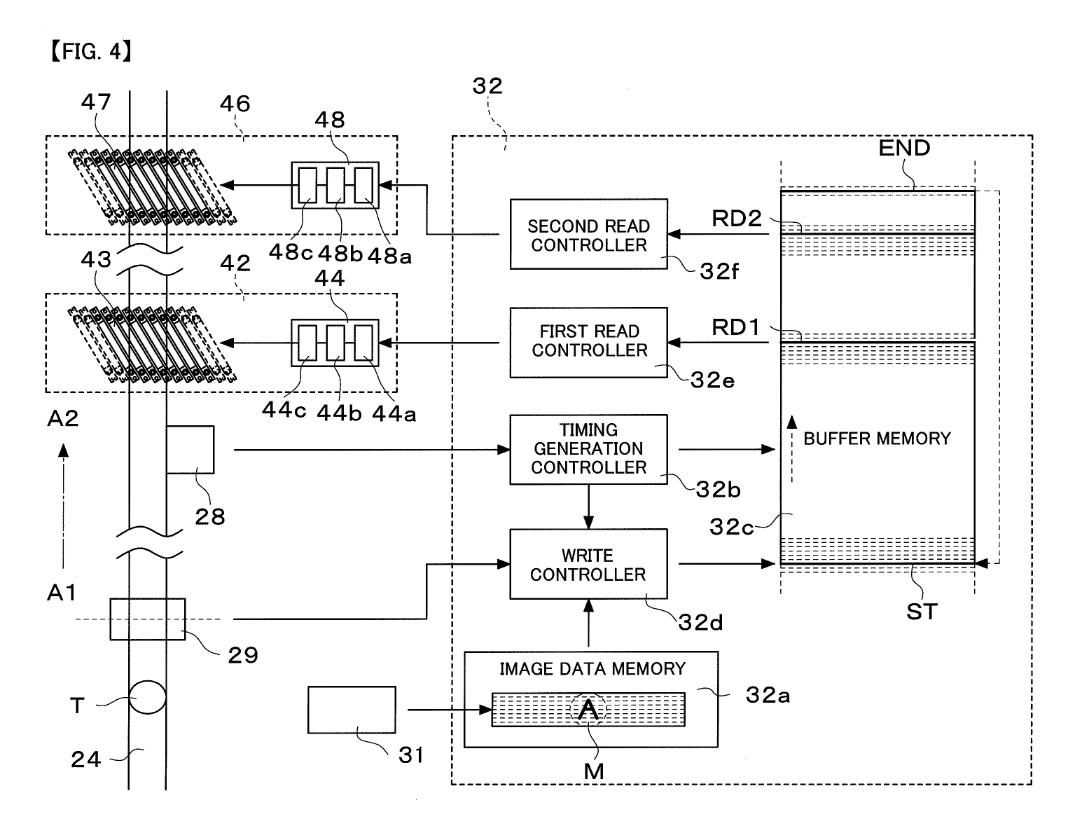

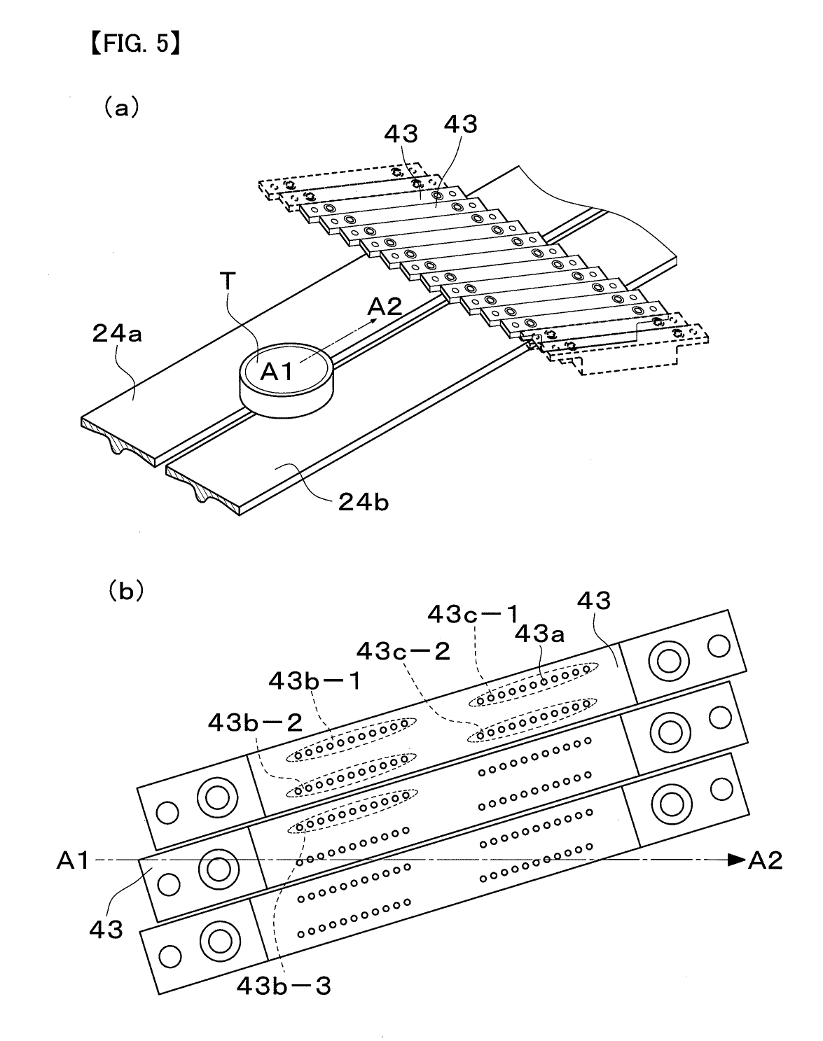

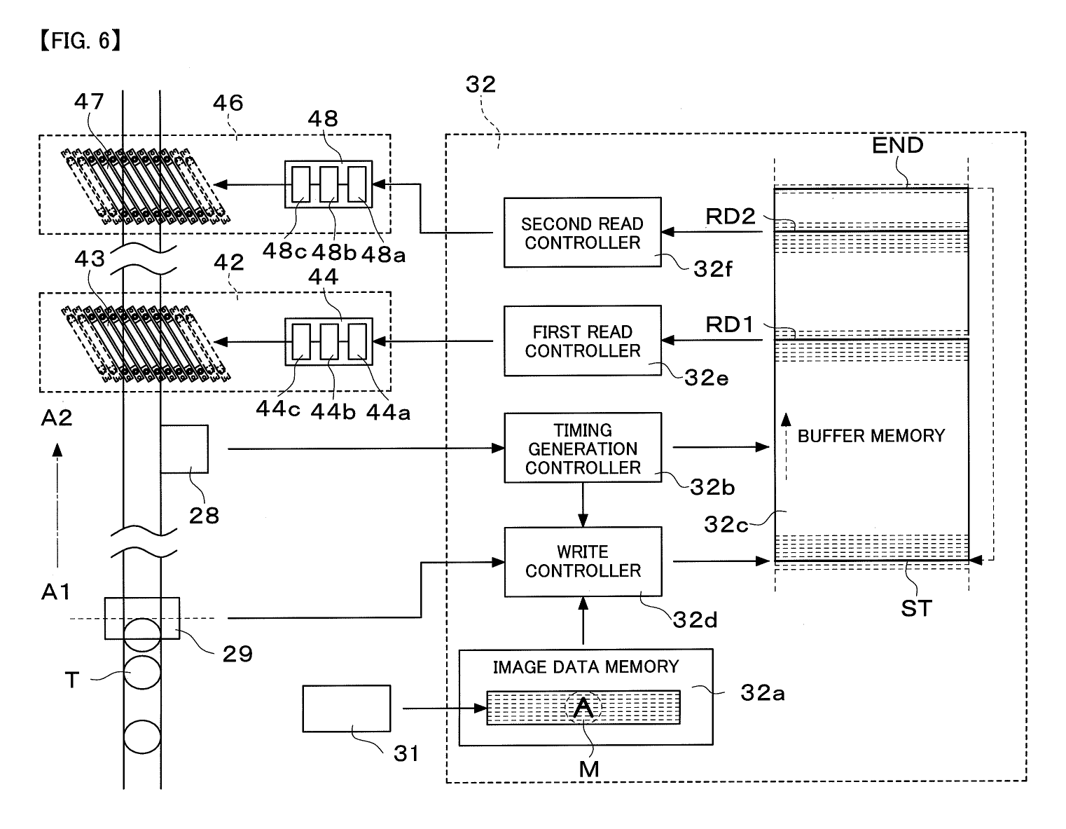

FIGS. 1 to 10 show an embodiment of a tablet printing apparatus according to the present invention, and FIG. 1 is a perspective view showing an entire configuration of the tablet printing apparatus; FIG. 2, a schematic view showing the entire configuration of the tablet printing apparatus; FIG. 3, a cross-sectional view showing conveying means in a direction vertical to a tablet moving direction; FIG. 4, a functional block diagram of a printer head control substrate and peripheral devices; FIG. 5, explanatory views of the printer head; and FIGS. 6 to 10, functional block diagrams each showing an outline of print processing with respect to tablets performed by the tablet printing apparatus.

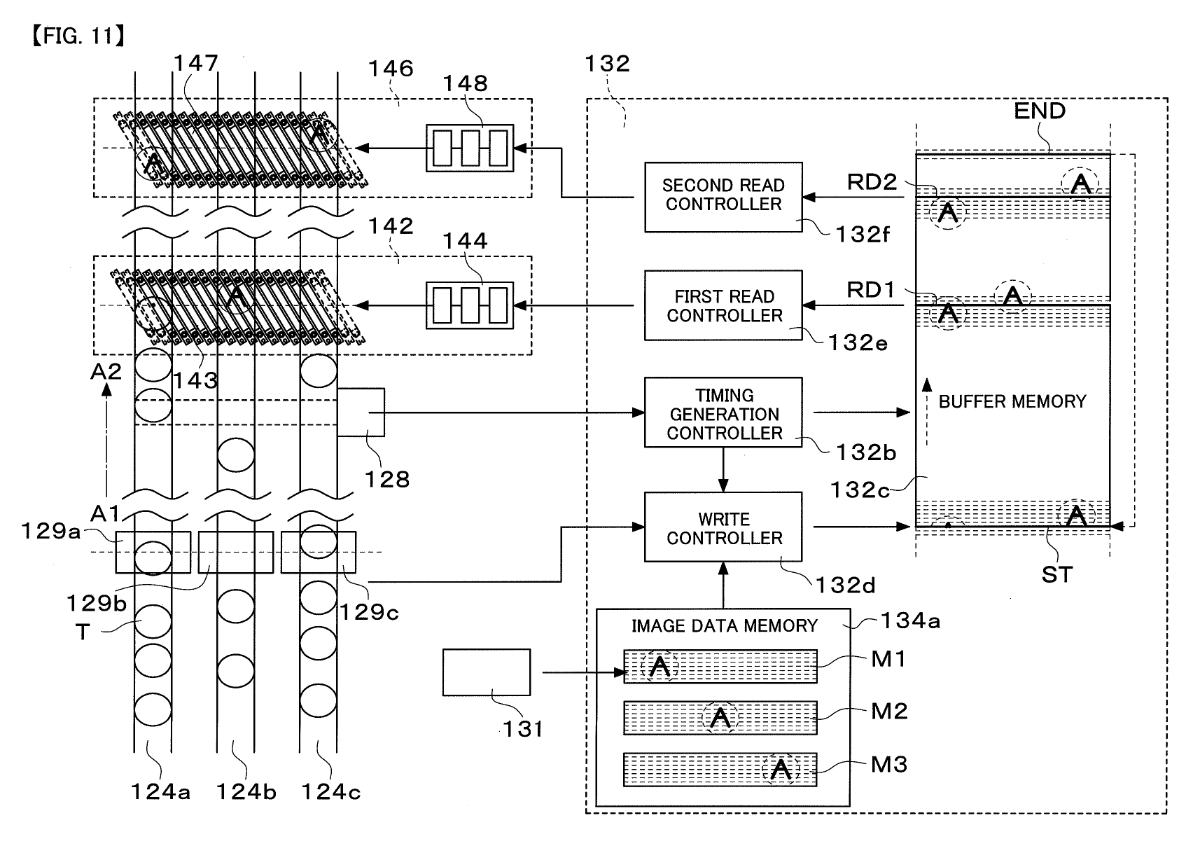

Further, FIG. 11 is a functional block diagram showing an outline of print processing with respect to tablets performed by a tablet printing apparatus according to another embodiment.

The tablet printing apparatus according to an embodiment of the present invention will now be described. The tablet printing apparatus according to the present invention is an apparatus that carries out single-color or polychromic printing with respect to tablets. Specifically, it is an apparatus that discharges one or more types of color inks onto tablets by using an inkjet printer to form color dots on tablet surfaces, thereby providing multiple colors (including color printing). It is to be noted that the single-color printing in this specification means printing effected in one color and the polychromic printing means printing in two or more colors including color printing.

It is to be noted that the embodiment explained below exemplifies a polychromic printing apparatus that performs printing with inks of different four colors as the tablet printing apparatus, but this apparatus can be also used as a single-color printing tablet printing apparatus that can perform printing with a single-color ink.

As shown in FIGS. 1 and 2, a tablet printing apparatus 1 according to this embodiment includes a housing 3, supplying means 10 that is provided in the housing 3 to supply tablets T, tablet conveying means 20 that is arranged to be continuous with the supplying means 10 and has a conveying path, position detecting means (an encoder 28, a tablet sensor 29), printing means 40 for performing printing by discharging inks to the tablets T conveyed by the tablet conveying means 20, printing controlling means (a control computer 31, a unit control substrate 32, and others), and examining means 50 arranged on a downstream side of the conveying path of the tablet conveying means 20 as main constituent elements.

The housing 3 is a square box type member that accommodates various kinds of devices such as a supply hopper 11, and an upper space partitioned by an intermediate plate 3a, a side plate 3b, and a top panel 3c is formed. It is to be noted that dotted lines indicate the side plate 3b and the top panel 3c to visualize various kinds of devices arranged in the upper space for facilitating the understanding of the invention. A circular opening 3d is formed in the top panel 3c on one end side in a longitudinal direction.

The supplying means 10 is provided under the opening 3d in the upper space of the housing 3. The supplying means 10 includes the supply hopper 11, a vibrating feeder 12 that is arranged below the supply hopper 11 and has a discharge opening, and a rectifying turntable 13 arranged below the discharge opening of the vibrating feeder 12.

The supply hopper 11 is a device that supplies the tablets T to the vibrating feeder 12, and it is formed of a funnel-shaped member that has a slot at an upper part and has a lower part with a reduced diameter. The supply hopper 11 is positioned in the upper space in such a manner that the slot coincides with the opening 3d of the top panel 3c, and each tablet T is put into the supply hopper 11 through the opening 3d of the top panel 3c.

The vibrating feeder 12 is a device that feeds the tablet T supplied from the supply hopper 11 to the rectifying turntable 13. The vibrating feeder 12 in this embodiment has a non-illustrated electromagnetic oscillator therein, and it can convey the tablet T by using oscillation energy generated by the electromagnetic oscillator.

One end side of the vibrating feeder 12 in the longitudinal direction is coupled with the lower portion of the supply hopper 11, and the other end side of the same is arranged above the rectifying turntable 13 to interpose a predetermined distance therebetween. The vibrating feeder 12 is formed of a horizontal portion that is placed on the supply hopper 11 side and horizontally arranged and an inclined portion that is placed on the rectifying turntable 13 side and has an end side obliquely inclined toward the lower side. On an end face of this inclined portion, a discharge opening from which the tablets T conveyed from the supply hopper 11 are dropped onto the rectifying turntable 13 is formed.

The rectifying turntable 13 is a device that brings the tablets T dropped from the vibrating feeder 12 into line and transfers them to the tablet conveying means 20. A rotatably provided discoid rotator, a peripheral wall vertically erected toward the upper side so as to surround an entire peripheral portion of the rotator, and a conveying path formed toward the tablet conveying means 20 from a part of the peripheral wall are provided on an upper surface of the rectifying turntable 13.

The tablets T that have dropped onto the upper surface of the rectifying turntable 13 roll and move to the outer periphery with the rotation of the rotator, and they align along the peripheral wall. Some of the tablets T that move along the peripheral wall are transferred to a conveying belt 24 of the tablet conveying means 20 through a conveying path provided on the peripheral wall.

The tablet conveying means 20 has a case body 21, the conveying belt 24 that revolves and moves on and in the case body 21, a motor 25 (not shown in FIG. 1) as driving means for rotating and driving the conveying belt 24, a plurality of pulleys 26 wound around the conveying belt 24, and a suction pump 27 (not shown in FIG. 1) as negative pressure means for forming a negative pressure in the case body 21 as main constituent elements.

FIG. 3 is a vertical cross-sectional view of the tablet conveying means 20 and shows a state from a direction of a line B-B in FIG. 2. As shown in this drawing, the case body 21 is formed of a square box body having an opened upper surface, and an accommodating space is formed in this case body.

A pair of left and right slit plates 22a and 22b are arranged in the opening of the case body 21 along the longitudinal direction of the case body 21. Each of the slit plates 22a and 22b is a member formed of a material such as aluminum. The slit plates 22a and 22b are fixed to the case body 21 in a state where they face each other in the horizontal direction, and a slit 20a serving as an inlet opening is formed between upper edges of the slit plates 22a and 22b. Respective opposite surfaces of the slit plates 22a and 22b protrude toward the other sides on the upper side, and a lateral width of the slit 20a is narrowed in this protruding region.

Upper surfaces of the slit plates 22a and 22b are subjected to, e.g., TUFRAM (registered trademark) processing, whereby skidding between these surfaces and the conveying belt 24 is smooth.

The conveying belt 24 is a member that conveys the tablets T, and it is configured as an endless belt that circulates on and in the case body 21 along the longitudinal direction of this body. The conveying belt 24 according to this embodiment has a configuration that two belts 24a and 24b are arranged in parallel and the slit 20a is formed between these belts. Further, each of the belts 24a and 24b in this embodiment is a timing belt having convex teeth formed on one surface thereof. As a material of the conveying belt 24, one that has appropriate elasticity and can adsorb and hold the tablets T can suffice, and rubber or plastic is used, for example.

The conveying belt 24 forms a conveying path on the upper surfaces of the slit plates 22a and 22b along the longitudinal direction. The conveying belt 24 is wound around an output shaft of the motor 25 and the plurality of pulleys 26 and can revolve and move based on the swiveling motion of the motor 25. A gear is disposed to the output shaft of the motor 25, and both the belts 24a and 24b are wound around this gear to form a state that convex teeth of the belts 24a and 24b and the gear mesh with each other. Furthermore, each of the plurality of pulleys 26 is formed of a timing pulley having concave portions formed to mesh with the convex teeth of the belts 24a and 24b, and both the belts 24a and 24b are wound around these pulleys 26 so that the convex teeth of the belts 24a and 24b mesh with the concave portions of the pulleys 26.

Since the belts 24a and 24b mesh with the pulleys 26 in this manner, slip does not occur between the belts 24a and 24b and the pulley 26 even if the conveying belt 24 is moved at a high speed. Therefore, the belts 24a and 24b can be moved at a high speed, thereby conveying the tablets T at a high speed. Furthermore, both the belts 24a and 26b mesh with the same pulleys 26, and hence the two belts 24a and 24b can revolve and move while synchronizing their speeds with each other. Accordingly, a difference in speed between the belts 24a and 24b is not produced, and displacement of the tablets T hardly occurs.

Protruding portions that protrude toward the lower side along the longitudinal direction are formed on the lower surfaces of the belts 24a and 24b. On the other hand, concave grooves in which the protruding portions of the belts 24a and 24b are fitted are formed on the upper surfaces of the slit plates 22a and 22b. The belt 24a revolves and moves along the concave groove in a state that the protruding portions are fitted in the concave groove of the slit plate 22a. Likewise, the belt 24b revolves and moves while being fitted in the concave groove of the slit plate 22b. Since the protruding portions of the belts 24a and 24b are fitted in the concave grooves of the slit plates 22a and 22b in this manner, the conveying belt 24 can be prevented from deviating in the lateral direction or coming off.

A hollow protruding portion 21a protruding toward the lower side is formed on the lower surface of the case body 21, and this protruding portion 21a is connected with the suction pump 27. The suction pump 27 is a device that sucks air in the case body 21 to form a negative pressure in the case body 21. The suction pump 27 is arranged in a lower space partitioned by the intermediate plate 3a (see FIG. 1) of the housing 3, and the protruding portion 21a of the case body 21 communicates with lower space through this intermediate plate 3a.

The inside of the case body 21 communicates with the outside through the slit 20a alone, and the airtightness is assured for any other portions. Therefore, when the suction pump 27 forms a negative pressure in the case body 21, outside air is sucked into the case body 21 through the slit 20a. The tablet T mounted on the upper surface of the conveying belt 24 in contact with the belts 24a and 24b is held and fixed in a state that they are adsorbed onto the upper surfaces of the belts 24a and 24b by suction of this outside air. In this state, the tablet T is conveyed toward a moving direction A1-A2 based on the swiveling motion of the conveying belt 24.

Since the tablet conveying means 20 according to this embodiment conveys the tablet T in the state that it is absorbed onto the conveying belt 24 as explained above, the tablet T hardly comes off even if the conveying belt 24 is moved at a high speed, thereby conveying the tablet T at a high speed.

It is to be noted that the absorption in the present invention includes fixing the tablet T by using the suction force. The tablet conveying means 20 is not restricted to one that adsorbs the tablet T onto the conveying belt 24 by suction using the pump like the embodiment, and the suction force (e.g., magnetic force or static electricity) may be generated by any other means to adsorb and hold the tablet T. Moreover, the tablet conveying means 20 is not restricted to such means using the suction force, and the conveying belt 24 having an adhesive layer formed on a surface thereof may be used to adsorb the tablet T onto the surface of the conveying belt 24.

Additionally, in this embodiment, the tablets T transferred from the rectifying turntable 13 can be sequentially adsorbed at irregular positions along the moving direction A1-A2 of the conveying belt 24 and conveyed every time they are transferred from the rectifying turntable 13 without aligning the tablets T at predetermined intervals. Therefore, the tablets T do not have to be aligned on the conveying belt 24 at predetermined intervals, and a wait time when transferring the tablets T from the rectifying turntable 13 to the conveying belt 24 is hardly produced. Accordingly, the tablets T transferred from the rectifying turntable 13 can be immediately conveyed, thereby reducing a tablet conveying time.

Further, since the tablets T are adsorbed onto the conveying belt 24, the tablets T are hardly displaced or come off even if the conveying belt 24 is moved at a high speed. Therefore, a rotating speed of the conveying belt 24 can be increased to move the tablets T at a high speed.

Although the conveying belt can move at a speed falling within the range of 500 mm/second to 2000 mm/second, the tablets T are conveyed at a moving speed of 1000 mm/second or above. Even if the tablets T are conveyed at a high speed in this manner, later-described position detecting means (the encoder 28, the tablet sensor 29) detects a moving state or a moving position of each tablet T, and printing controlling means adjusts printing onto each tablet, thereby enabling printing at an accurate position with respect to the tablet T.

Again referring to FIGS. 1 and 2, the encoder 28 is means which is disposed to one of the pulleys 26 and detects a rotating position of the pulley 26. The encoder 28 detects a rotating position or/and a rotating state of the pulley 26 in this manner to acquire a moving position or/and a moving state of the conveying belt 24 wound around the pulleys 26. As a result, a moving state or/and a moving position of each tablet T can be indirectly acquired.

As the encoder 28, a known rotary encoder can be used. As a type of the rotary encoder, an absolute type or an incremental type can be adopted.

Further, the means for detecting a position of each tablet T is not restricted to the above-described encoder 28, any other means for magnetizing the conveying belt at predetermined intervals and detecting a moving position or/and a moving state of the conveying belt by using a magnetic sensor may be used, for example.

The tablet sensor 29 is means that is provided above the conveying belt 24 on an upstream side and detects each tablet T conveyed on the conveying belt 24. Furthermore, as the tablet sensor 29, for example, an infrared sensor adopting a scheme that an infrared ray is emitted toward the slit 20a of the conveying belt 24 and the infrared ray is blocked when the tablet T passes can be used. When the tablet T is detected, the tablet sensor 29 outputs a tablet detection signal. It is to be noted that, as the tablet sensor 29, one using any other optical detecting means or means other than the optical means, e.g., a nearby sensor that detects a change in electrostatic capacitance can be used.

The encoder 28 and the tablet sensor 29 can acquire a moving position of each tablet T conveyed by the conveying belt 24. That is, the tablet sensor 29 detects that the tablet T has passed a predetermined position, and the encoder 28 counts an output pulse signal, thereby measuring a moving position of the conveying belt 24. The pulse signal output from the encoder 28 is, e.g., a pulse number output during elapse of 10 μs, and a signal in units of 10 ns obtained by integrating a wavelength per pulse number with respect to the output pulse number can be used.

Moreover, a later-described ink discharge signal can be configured to be output in synchronization with the pulse signal output from this encoder 28. In this case, the output pulse signal of the encoder 28 is matched with a print resolution in advance. Additionally, the print resolution, a conveying speed of the tablet T, and an ink discharge frequency (Hz) have a close relationship, and the ink discharge frequency is a moving distance in units of millimeter/an interline distance in units of print resolution per second. For example, when performing printing with a moving distance of 75 meters/minute at 600 dpi, there is a relationship of (75/60×1000)/(25.4/600)=29527.56 Hz.

As a result, it is possible to indirectly perceive a position to which the tablet T has been conveyed from the tablet detected position obtained by the tablet sensor 29.

In this manner, the encoder 28 and the tablet sensor 29 are means that acquire a moving position and a moving state of the tablet T in cooperation with each other, and both these members constitute the position detecting means in the present invention.

The printing controlling means 30 is formed of the control computer 31, the unit control substrate 32, and others.

The control computer 31 includes a central processing unit (a CPU), a storage device (e.g., an HDD, an ROM, or an RAM), an input/output interface, and others, and the control computer 31 and the later-described unit control substrate 32 constitute the printing controlling means according to the present invention. This control computer 31 performs the management of the entire apparatus, e.g., ON/OFF of a power supply of the entire apparatus, various kinds of settings or changes in the entire apparatus, display of a state of the entire apparatus, and others.

For example, appropriate settings can be formed in accordance with a shape or a size of the tablet T as a printing target, a processing speed for the tablet T by the tablet printing apparatus 1, an installation environment of the tablet printing apparatus 1, and others. For example, in this embodiment, a distance between a nozzle hole 43a and the tablet T is approximately 2 mm, a bore diameter of the nozzle hole 43a is approximately 20 μm, an ink discharge amount (per droplet) is approximately 11 picoliters, a distance from the tablet sensor 29 to a printer head 43 is approximately 120 mm, and a distance from the printer head 43 to a printer head 47 is approximately 850 mm.

Additionally, according to the control computer 31, a print image of the tablet T can be directly created by an operator, or a print image created by an external device can be input. The print image is data that is created in a format such as bitmap or JPEG and has pixels represented by three primary colors of light including RGB (red, green, and blue) as constituent units. The created or input print image is stored in the control computer 31. The control computer 31 is electrically connected with the unit control substrate 32 and outputs a stored print image to the unit control substrate 32.

The unit control substrate 32 is a substrate that controls inkjet printers 42 and 46, and it is electrically connected with respective printer head control substrates 44 and 48 of the inkjet printer 42 and the inkjet printer 46 through buses to input/output a control signal or image data. Further, the unit control substrate 32 is also connected with the encoder 28 and the tablet sensor 29, and it processes and outputs a print image based on a pulse signal supplied from the encoder 28 or a tablet detection signal fed from the tablet sensor 29.

As shown in FIG. 4, the unit control substrate 32 has an image data memory 32a that stores an image to be printed on the tablet T in a master image M, a timing generation controller 32b that generates a timing signal based on a signal from the encoder 28, a buffer memory 32c that temporarily stores the master image M of the image data memory 32a, a write controller 32d that controls writing the master image M into the buffer memory 32c based on a tablet detection signal from the tablet sensor 29 and a timing signal from the timing generation controller 32b, a first read controller 32e that controls reading the master image M from the buffer memory 32c, and a second read controller 32f that controls reading the master image M from the buffer memory 32c as main constituent elements.

The image data memory 32a is means for storing an image to be printed onto the tablet T as the master image M. The master image M is image data having a format such as bitmap created by the control computer 31 and includes in a column direction a plurality of pieces of row data (line data) each associated with an image (a raster image) corresponding to one line along the moving direction A1-A2 of the tablets T.

The timing generation controller 32b is means for controlling transfer of an address of line data stored in the buffer memory 32c and writing of line data into the buffer memory 32c by the controller 32d in synchronization with a pulse signal from the encoder 28. The timing generation controller 32b generates a latch signal as a timing signal every time it receives a pulse signal cyclically output from the encoder 28, and transmits it to the buffer memory 32c and the write controller 32d.

The buffer memory 32c is means for temporarily storing the master image M stored in the image data memory 32a in accordance with each line data. The buffer memory 32c according to this embodiment is formed of an FIFO type ring buffer. That is, the buffer memory 32c is a fixed-length buffer having a start address ST and an end address END and has a configuration that an address following the end address END coincides with the start address ST.

The buffer memory 32c has at least a capacity that can store a line number obtained by dividing a physical distance from a position immediately below the tablet sensor 29 to a position immediately below the printer head (i.e., a printing point) by a printing unit of the line head.

Moreover, the buffer memory 32c includes a pointer control circuit (not shown), and a pointer specified by this pointer control circuit specifies a write address and a read address for data in a memory array.

A first read address RD1 and a second read address RD2 are provided in the buffer memory 32c. The first read address RD1 is associated with a position immediately below the printer head 43 of the inkjet printer 42. Additionally, the number of lines that can be stored in a space between the start address ST and the first read address RD1 coincides with the number obtained by dividing a physical distance from a position immediately below the tablet sensor 29 to a position immediately below the printer head 43 by a printing unit of the line head.

The second read address RD2 is placed on the end address END side apart from the first read address RD1. The second read address RD2 is associated with a position immediately below the printer head 47 of the inkjet printer 46. Further, the number of lines that can be stored in a space between the first read address RD1 and the second read address RD2 coincides with the number obtained by dividing a physical distance from the position immediately below the printer head 43 to the position immediately below the printer head 47 by the printing unit of the line head.

The write controller 32d is means for reading line data from the image data memory 32a and writing it into the buffer memory 32c based on a tablet detection signal from the tablet sensor 29. When the write controller 32d receives the tablet detection signal from the tablet sensor 29, it reads out line data corresponding to one line from the master image M of the image data memory 32a at a timing of receiving a latch signal from the timing generation controller 32b and writes it at the start address ST of the buffer memory 32c.

At this moment, the pointer control circuit of the buffer memory 32c receives the latch signal from the timing generation controller 32b, instructs the buffer memory 32c to move a pointer, and shifts the address at which the master image M is stored in the buffer memory 32c toward the end address END side in increments of predetermined bits.

With such a configuration, the buffer memory 32c sequentially stores line data read from the image data memory 32a in the column direction in synchronization with the rotation of the encoder 28, and shifts already stored line data toward the end address END.

The first read controller 32e is means for reading out image data stored at the read address RD1 of the buffer memory 32c and outputting it to the printer heads 43 via the printer head control substrate 44. When an address of the master image M is shifted to be placed at the first read address RD1 by the timing generation controller 32b, the first read controller 32e reads out the master image M from the buffer memory 32c. The read master image M is output to the printer head control substrate 44 of the inkjet printer 42.

The second read controller 32f is means for reading image data stored at the read address RD2 of the buffer memory 32c and outputting it to the printer heads 47 through the printer head control substrate 48. When an address of the master image M is shifted to be placed at the second read address RD2 by the timing generation controller 32b, the second read controller 32f reads the master image M from the buffer memory 32c. The read master image M is output to the printer head control substrate 48 of the inkjet printer 46.

The inkjet printers 42 and 46 will now be described.

The inkjet printer 42 according to this embodiment is a printer unit that discharges yellow/magenta inks onto the tablet T to print yellow/magenta images. On the other hand, the inkjet printer 46 is a printer unit that discharges cyan/black inks onto the tablet T to print cyan/black images.

As shown in FIG. 2, the inkjet printer 42 includes the plurality of printer heads 43 that discharge the ink toward the tablets T, the printer head control substrate 44 that controls these printer heads 43, and a sub-tank 45 that stores the ink. An ink tank 41 that stores yellow, magenta, cyan, and black inks is arranged above the inkjet printers 42 and 46. Printing means 40 according to this embodiment adopts a line head scheme that the printing means 40 is fixed in a state that the plurality of printer heads 43 are arranged at predetermined positions above the conveying belt 24 in parallel and the tablets T themselves as printing targets move.

The printer head 43 is a device that discharges droplets of the ink toward each tablet T. Each printer head 43 includes an ink chamber that accommodates the ink, nozzle holes communicating with the outside from the ink chamber, a piezo element (a piezo actuator) as an actuator that applies a pressure to the ink in the ink chamber to be discharged from the nozzle holes, and an electrode that applies a voltage for transforming the piezo element as main constituent elements (all the elements are not shown).

The ink chamber communicates with the sub-tank 45, and it is filled with the ink accommodated in the sub-tank 45. The sub-tank 45 communicates with the ink-tank 41, and it can accommodate a yellow ink and a magenta ink stored in the ink tank 41, respectively. The nozzle holes are formed at a lower part of the ink chamber so that the ink filling the ink chamber can be discharged toward the outside.

The piezo element is arranged on an opposite side of the nozzle holes in the ink chamber. The piezo element is configured to be sandwiched between a pair of electrodes, and it has properties of transforming in response to a voltage applied from a non-illustrated power supply connected with this electrodes. When the piezo element transforms, a volume in the ink chamber varies, and a part of the ink in the ink chamber is discharged through the nozzle holes.

As the piezo element according to this embodiment, a piezo thin film formed by controlling polarizing directions is used. The piezo thin film is a thin film that is formed of, e.g., a lead zirconate titanate (Pb(Zrₓ,Ti₁₋ₓ)O₃) and has a film thickness of approximately 2 to 5 μm, and it is formed by a technique such as sputtering. This piezo thin film element has a configuration that polarizing directions are aligned in one direction as compared with a general sintered body piezo element produced by sintering a material. Therefore, the piezo thin film has a high electric field intensity and high piezoelectric properties, and its electromechanical conversion efficiency or intensity is approximately double a counterpart of the sintered body piezo element. Therefore, the number of nozzle holes per unit area is highly integrated to be double a counterpart of the conventional sintered body piezo element.

The printer head 43 will now be described hereinafter in detail. FIG. 5(a) is a perspective view showing the printer heads 43 from an obliquely upper side. As shown in this drawing, the plurality of printer heads 43 are arranged in parallel in this embodiment. Further, each printer head 43 is arranged to be inclined in an oblique direction with respect to the moving direction A1-A2 of the tablets T.

FIG. 5(b) is a bottom view showing the printer heads 43 from the lower side in a state where the nozzle holes are seen from the front side. As depicted in this drawing, a plurality of circular nozzle holes 43a are provided in the printer heads 43, and the ink is discharged toward the tablets T from these nozzle holes 43a.

In each printer head 43, two nozzle hole columns are formed along the longitudinal direction, and the respective nozzle hole columns are separated on left and right sides at a central portion of the printer head 43. The left and right nozzle hole columns are formed as a nozzle hole column group 43b (43b-1, 43b-2) and a nozzle hole column group 43c (43c-1, 43c-2), respectively. Further, two columns on one end side in the longitudinal direction of the printer head 43 correspond to yellow nozzle hole columns 43b-1 and 43b-2, and two columns on the other end side of the same correspond to magenta nozzle hole columns 43c-1 and 43c-2.

The printer head 43 according to this embodiment is arranged in such a manner that an aligning direction of the nozzle holes 43a is inclined in the oblique direction with respect to the moving direction A1-A2 of the tablets T. Although depending on the arrangement of the nozzle holes 43a, an inclination angle of the aligning direction of the nozzle holes 43a with respect to the moving direction A1-A2 is approximately 5 to 60°.

When the printer head 43 is arranged at a slant in this manner, the nozzle holes 43a are arranged to be inclined with respect to the moving direction A1-A2. When the respective nozzle holes 43a are translated to be aligned along a perpendicular direction (i.e., a width direction of the conveying belt 24) of the moving direction A1-A2, they are arranged at positions at which they are aligned at equal intervals to overlap some of the adjacent nozzle holes 43a.

Furthermore, in the yellow nozzle hole column 43b-1 and the yellow nozzle hole column 43b-2 adjacent thereto, the nozzle holes 43a adjacent to each other are aligned at equal intervals in a state that they partially overlap each other when projection is carried out along the perpendicular direction of the moving direction A1-A2. Moreover, in the yellow nozzle hole column 43b-2 and a yellow nozzle hole column 43b-3 of another printer head 43 adjacent thereto, the nozzle holes are likewise aligned at equal intervals.

That is, when projection is performed in such a manner that the nozzle holes 43a in all the yellow nozzle hole columns 43b-1 to 43b-3 including the adjacent printer heads 43 are aligned in the perpendicular direction of the moving direction A1-A2, the nozzle holes 43a adjacent to each other are arranged at equal intervals so as to partially overlap.

When each printer head 43 is inclined with respect to the perpendicular direction (the width direction of the conveying belt 24) of the moving direction A1-A2, the number of the nozzle holes 43a per unit length in the width direction of the conveying belt 24 increases, thereby highly integrating the nozzle holes 43a. Therefore, a resolution of identifying information printed on the tablets T can be improved.

It is to be noted that the nozzle holes 43a in the magenta nozzle hole columns 43c-1 and 43c-2 are arranged in the same manner.

The printer head control substrate 44 will now be described. The printer head control substrate 44 is means for collectively controlling the plurality of printer heads 43 arranged in parallel.

That is, the printer head control substrate 44 receives print data (line data) from the unit control substrate 32, drives and controls the plurality of printer heads 43 based on this line data to perform printing on the tablets T.

As shown in FIG. 4, the printer head control substrate 44 includes a storage section 44a that stores the line data supplied from the unit control substrate 32, a color converting section 44b that coverts RBG information for each pixel in the line data into color information of CMYK (cyan, magenta, yellow, and black), and a head output section 44c that drives the printer heads 43 based on the color information from the color converting section.

The storage section 44a is formed of a memory such as an RAM, and it temporarily stores the line data (RGB information) supplied from the unit control substrate 32.

The color converting section 44b is formed of an arithmetic device such as a DSP, and it reads out the line data stored in the storage section 44a and converts it into color information of CMYK. The line data fed from the unit control substrate 32 is constituted of 256-gradation data of RGB, and the color converting section 44b converts this RGB data into 256-gradation data of CMYK. The color-converted line data is supplied to the head output section 44c.

The head output section 44c receives and sorts the line data and drives and controls the printer heads 43 based on data of yellow (Y) and magenta (M) alone in CMYK.

Giving a more detailed explanation, the head output section 44c receives the CMYK color information and executes processing of sorting the color information of yellow (Y) and magenta (M) in a discharge order. In this sorting, the data is sorted and stored in a memory such as a non-illustrated RAM of the head output section 44c in such a manner that the data is output in an ink discharge order of the ink holes 43a of the printer heads 43.

Here, the ink discharge order is an order that the tablets T are conveyed along the moving direction of the tablets T. Specifically, in the ink holes 43 of the yellow nozzle hole columns 43b-1 and 43b-2 in FIG. 5(b), this order is an order from the left-hand side (an upstream side) to the right-hand side (a downstream side).

Then, the head output section 44c outputs the data of yellow and magenta in the color information of CMYK to the printer heads 43.

When each printer head 43 receives the data, it drives the piezo elements at positions associated with the respective ink holes 43a so as to discharge the yellow ink from the nozzle holes 43a of the yellow nozzle hole columns 43b-1 and 43b-2 and discharge the magenta ink from the nozzle holes 43a of the magenta nozzle hole columns 43c-1 and 43c-2.

When the ink is discharged sequentially from the ink holes 43a on the upstream side along the moving direction of the tablets T in this manner, an image (yellow and magenta) corresponding to one line along the perpendicular direction of the moving direction A1-A2 is printed on a surface of the tablet T upon end of output of data corresponding to one line.

The above has described the inkjet printer 42, the inkjet printer 46 has the similar configuration. That is, the inkjet printer 46 includes the printer heads 47, the printer head control substrate 48, and a sub-tank 49 as main constituent elements. The sub-tank 49 communicates with the ink tank 41 and can accommodate the cyan ink and the black ink stored in the ink tank 41.

It is to be noted that these constituent elements except the printer head control substrate 48 are the same as those described in relation to the inkjet printer 42, thereby omitting a detailed explanation thereof.

The printer head control substrate 48 includes a storage section 48a that stores line data supplied from the unit control substrate 32, a color converting section 48b that converts RGB information for each pixel of the line data into color information of CMYK, and a head output section 48c that drives the printer heads 47 based on the color information from the color converting section.

The color converting section 48b reads the line data stored in the storage section 48a and converts it into color information of CMYK.

The head output section 48c drives and controls the printer heads 47 based on data of cyan (C) and black (K) alone in CMYK as different from the head output section 44c. Each printer head 47 discharges the cyan ink and the black ink toward each tablet T based on a control signal from the head output section 48c. As a result, in the inkjet printer 46, images of cyan and black are printed on each tablet T.

The examining means 50 includes a printing section examination unit 51 and a quality judgment unit 52 provided to be adjacent to the printing section examination unit 51.

The printing section examination unit 51 is means for detecting identifying information printed on a printed surface of the tablet T. The printing section examination unit 51 includes, e.g., a CCD color camera, shoots each tablet T, and transmits acquired data to the quality judgment unit 52.

The quality judgment unit 52 is means for judging whether printing on each tablet T is good. The quality judgment unit 52 stores a good printing pattern in the storage device in advance and compares imaging data of each tablet T supplied from the printing section examination unit 51 with the good printing pattern to judge whether a predetermined image has been printed on the tablet T. When it is determined that the predetermined pattern has not been printed on the tablet T as a result of the judgment, the tablet T is collected as a defective product through a route different from that for a group of other good products.

The tablet as a printing target of the tablet printing apparatus according to the present invention will now be described.

Although a type of the tablet subjected to printing by the tablet printing apparatus is not restricted in particular, printing can be effected with respect to a core tablet (a plain tablet) obtained by just carrying out shape forming of a raw material including active substances without surface coating or a coating tablet obtained by coating a surface of a core tablet with saccharose or a water-soluble polymer.

Further, as a tablet shape forming method, there is, e.g., a compression forming method for tableting a raw material to form a shape or a non-compression forming method for drying in a mold a raw material subjected to wet kneading without tableting.

Since the tablet printing apparatus 1 according to this embodiment can perform printing in a non-contact manner, it can be preferably used with respect a core tablet that is difficult to be subjected to clear printing in regular offset printing since a powder adheres to a surface.

As a type of the core tablet, there is, e.g., an orally-disintegrating tablet. Since the orally-disintegrating tablet is a medicinal substance that orally solves in saliva to turn to a liquid medication and can be taken without water, it is characterized in that even aged persons or children who have difficulty in swallowing can easily take such a tablet or taking such a tablet is easy even in an environment that water is difficult to obtain.

The orally-disintegrating tablet can be roughly divided into a template tablet produced by non-compression forming, a molded tablet formed by performing tableting under a very low pressure, and a compressed tablet formed by performing tableting under a relatively high tableting pressure.

Several specific production methods or prescriptions of each tablet will now be described. It is to be noted that the production methods or prescriptions described below are just examples and the tablet according to the present invention is not restricted to those produced based on these production methods or prescriptions.

The template tablet can be produced by precisely filling a casting mold with chemicals, sugars, binders, and others and removing moisture by freeze drying or low-temperature draught drying. As a specific example of such a template tablet, there is “Zydis” (a product name: Zofran (a registered trademark) Zydis (a registered trademark)).

The molded tablet is a tablet that can be produced by tableting while maintaining porosity equivalent to that of the template tablet, and it is produced by, e.g., moistening a mixture of chemicals, sugars, and a binder with a mixed liquid of a small amount of water and alcohol and molding this moist mixture under a very low pressure to be dried.

Further, as the molded tablet, it is possible to adopt a tablet that is produced by, e.g., a tableting machine incorporating a pressurized weight filling mechanism and a polymeric film intervening forming mechanism for avoiding attachment.

The compressed tablet is produced by tableting chemicals, a binder, and others by a general tabling facility. Since the compressed tablet is formed under a tableting pressure higher than that for the template tablet or the molded tablet, it has high hardness and a low void ratio as compared with these tablets. It is to be noted that the compressed tablet may contain sugar for maintaining high porosity or an additive having a disintegrating function.

The compressed tablet can be manufactured by granulating sugar having low formability by using sugar having high formability and compressing and forming the granulated sugar. Such a compressed tablet is obtained by applying disintegrating properties provided by the sugar that is superior in disintegrating properties but has low formability and physical characteristics with different tablet formability provided by the sugar that is inferior in disintegrating properties but has high formability, and it has predetermined strength and characteristics of rapid disintegration in the oral cavity.

As the sugar having low formability, there is sugar selected from, e.g., lactose, mannitol, glucose, saccharose, xylitol, and others. Furthermore, as the sugar having high formability, there is sugar selected from maltose, maltitol, sorbitol, lactose and fructose, and others. When the sugar having high formability is used as a binder and the sugar having low formability is sprayed for coating/granulation, an orally-disintegrating type compressed mold product can be obtained.

Moreover, the compressed tablet can be also obtained by performing compression forming with sugar (A) and amorphous sugar (B) being used as binders. This compressed tablet has tablet strength improved by utilizing a change in physicality due to transition from an amorphous material to a crystal of the sugar. The sugar (A) is sugar or sugar alcohol that can solve in the oral cavity, and there are, e.g., lactose, glucose, trehalose, mannitol, erythritol, and others. Additionally, the amorphous sugar (B) means sugar in an amorphous state or sugar that is going to be amorphous, it is obtained by dissolving crystalline sugar that is going to be amorphous in a solvent such as water or alcohol, removing the solvent from this dissolved liquid, and effecting drying. An additive amount of the amorphous sugar (B) is approximately 2 to 20 weight % with respect to the sugar (A).

Further, the compressed tablet may be a compressed tablet obtained by performing compression forming with respect to a microcapsulated chemical and a foam disintegrating agent that foams with moisture (an organic acid and a carbonate) together with a diluting agent. As the organic acid, at least one acid is preferably selected from a group including a citric acid, a tartaric acid, a malic acid, a fumaric acid, an adipic acid, a succinic acid, an acid anhydride obtained from these acids and salt, and mixtures of these materials. The tablet disintegration of this compressed tablet advances when the foam disintegrating agent foams due to permeation of saliva in the mouth to help disintegration of the tablet and saliva production is facilitated by stimulation of the foam.

Further, the compressed tablet may be a tablet that contains active substances as fine crystals or fine particles and that can be obtained by mixing the effective substances with a disintegrating agent and an expansive agent to be subjected to compression forming. There are carboxymethyl cellulose, reticular polyvinyl pyrrolidone, and others as the disintegrating agent, and there are microcrystalline cellulose, starch, modified starch, and others as the expansive agent.

Furthermore, the compressed tablet may be a tablet obtained by performing compression forming by using a special tableting machine. As such a tablet, there is, e.g., a tablet obtained by spraying a lubricant onto surfaces of a mortar and a pestle to be diffused by a high-tension pulse air generation apparatus and effecting external lubricant tableting. Since the lubricant can be uniformly diffused with respect to desired regions of the mortal and the pestle by using the high-tension pulse air, an additive amount can be reduced to at least 1/10 of a regular amount as compared with the conventional method, and a quality of the tablet can be also improved.

Besides, there is a tablet formed by combining two disintegrating tablets, i.e., fine crystalline cellulose and low-substitution degree hydroxypropylcellulose.

As a shape of the core tablet, it is possible to adopt not only a circular shape seen in a planar view but also any shapes such as an elliptic shape, a long elliptic shape, a triangular shape, a square shape, or a polygonal shape as long as it is a shape that can be conveyed by the tablet conveying means 20.

Although a void ratio indicative of a degree of porosity of the tablet is not restricted in particular, the ink is apt to permeate pores of the tablet as the void ratio is high, and a powder amount on the surface is also increased, whereby bleeding or detachment of the ink readily occurs. Therefore, it is preferable for the void ratio to fall within the range of 5% to 40%, more preferably the range of 5% to 35%, or the range of 5% to 30% as another preferred conformation. When the void ratio is in this range, bleeding or detachment of the printed ink hardly occurs, and the identifying information can be clearly printed on the surface of the tablet. Moreover, when the void ratio is 40% or below, moisture-absorption characteristics are low, and disintegration of the tablet due to moisture contained in the ink hardly occurs, which is preferable.

It is to be noted that active substances contained in the tablet are not restricted in particular, and substances configured to have desired components can be determined as the active substances depending on medical benefits of each tablet. As particularly preferred active substances contained in the tablet, there are famotidine, tamsulosin hydrochloride, and others.

As described above, the tablet printing apparatus according to the present invention can be preferably used with respect to the tablets, but it can be also used with respect to other solid medicines such as capsules or trochiscis besides the tablet.

Additionally, it can be also used with respect to sweets such as a lemon soda or block sugar and food items.

That is, printing can be basically performed with respect to small goods including the tablet as long as they can be conveyed by the conveying device and on which the identifying information can be printed.

In the present invention, as a usable ink, an edible ink that is safe even if ingested by persons is preferable. The edible ink is a constituent mainly including an edible dye, a water-soluble solvent, and purified water.

As the edible dye, a dye that is in a specified additive list in artificial colors determined by a food hygiene law is preferable.

As the identifying information printed on the surface of the tablet, there are characters, figures, photographic images, and others. For example, a product name of a medical agent, a titer, a pharmaceutical manufacturer name, a pharmaceutical manufacturer logo, and others can be printed.

A tablet production method for the tablets T using the tablet printing apparatus 1 will now be described.

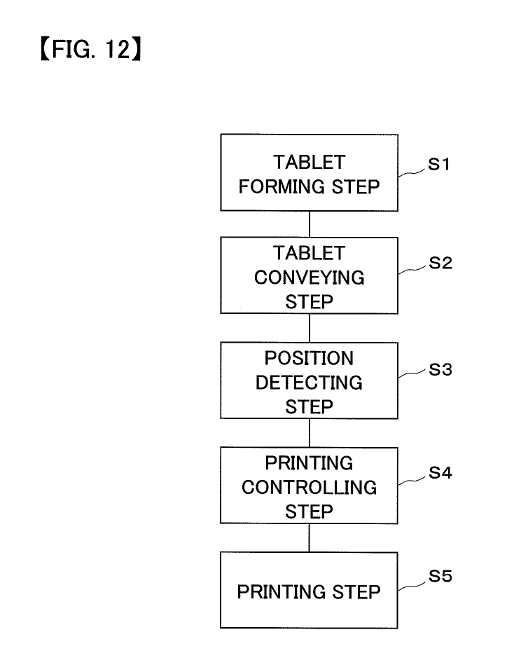

As shown in FIG. 12, the tablet production method according to this embodiment includes a tablet forming step S1, a tablet conveying step S2, a position detecting step S3, a printing controlling step S4, and a printing step S5. As a result, printing can be effected onto each tablet irregularly conveyed in high volume at a high speed.

First, at the tablet forming step S1, a raw material containing active substances is utilized to form tablets based on compression forming by a known technology.

Then, the tablet conveying step S2 is executed. At this tablet conveying step S2, as shown in FIG. 2, the tablets T are first supplied to the supply hopper 11 and then fed to the rectifying turntable 13 by vibration energy of the vibrating feeder 12. The tablets T supplied to the rectifying turntable 13 are sequentially pushed out onto the conveying belt 24 of the tablet conveying means 20 in a state that they are aligned in line by the rotator.

The tablets T pushed out and mounted on the conveying belt 24 are held and fixed on the conveying belt 24 by the suction pump 27 and conveyed in the moving direction A1-A2 at a high speed.

Then, the position detecting step S3 is carried out. As shown in FIG. 6, the tablet sensor 29 is provided in the middle of the conveying path of the tablet conveying means 20, the tablets T conveyed immediately below the tablet sensor 29 are detected by the tablet sensor 29, and a tablet detection signal is generated. The tablet detection signal is input to the write controller 32d of the unit control substrate 32.

Furthermore, a predetermined number of pulse signals are output per rotation from the encoder 28 coupled with the pulley 26 while the conveying belt 24 rotates. The pulse signals are input to the timing generation controller 32b of the inkjet printer 42 through the unit control substrate 32.

Then, the printing controlling step S4 is effected. The timing generation controller 32b generates a latch signal synchronized with each pulse signal to be output to the write controller 32d and the buffer memory 32c.

The write controller 32d receives the tablet detection signal from the tablet sensor 29, then reads line data corresponding to one line of the master image M from the image data memory 32a at a timing of receiving the latch signal from the timing generation controller 32b for the first time, and writes the read data at the start address ST in the buffer memory 32c.

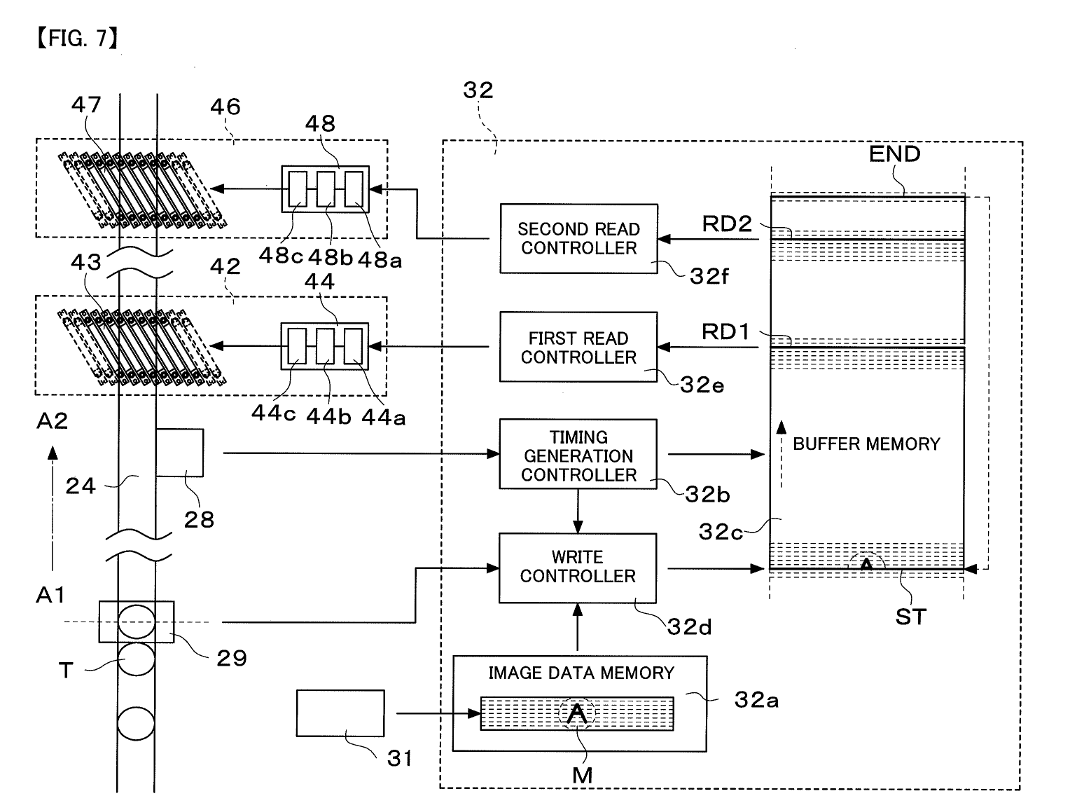

As shown in FIG. 7, the timing generation controller 32b shifts an address storing the master image M stored in the buffer memory 32c toward the end address END for predetermined bits every time the pulse signal is received. The write controller 32d sequentially reads the line data of the master image M stored in the image data memory 32a for each line in the columnar direction in synchronization with this address shift, and writes the read data at the start address ST in the buffer memory 32c. As a result, the master image M is sequentially written into the buffer memory 32c in accordance with each line.

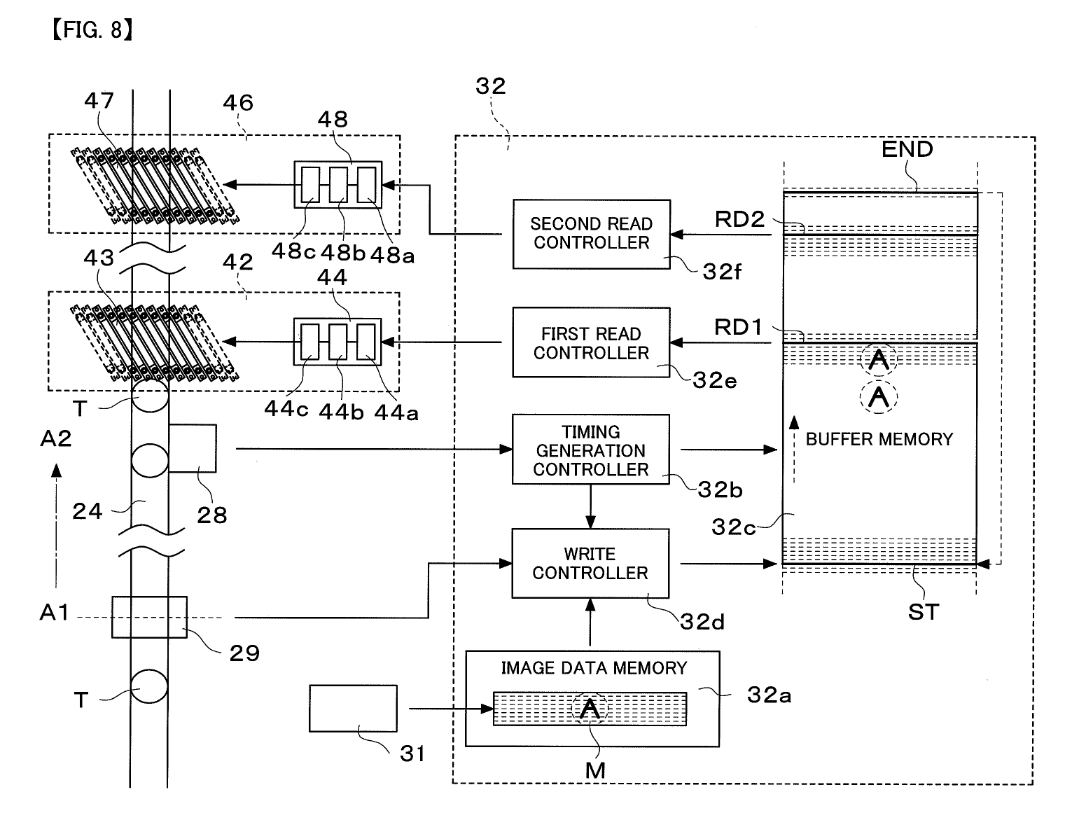

As shown in FIG. 8, when the pulse signals are output from the encoder 28 for a predetermined number of times, the line data in the first line of the master image M reaches the first read address RD1. The first read address RD1 in the buffer memory 32c is a position corresponding to a place immediately below the printer head 43. The first read controller 32e reads the line data of the master image M stored at the first read address RD1 and outputs it to the printer head control substrate 44 of the inkjet printer 42.

Subsequently, the printing step S5 is effected. In the printer head control substrate 44, the line data is temporarily stored in the storage section 44a, this data is converted into color information of CMYK by the color converting section 44b, then, the head output section 44c outputs yellow and magenta information to the printer heads 43, and ink discharge control is effected. The printer heads 43 discharge the yellow ink and the magenta ink toward the tablets T based on the yellow and magenta information supplied from the head output section 44c. As a result, images of yellow and magenta in the line data are printed on the surface of each tablet T.

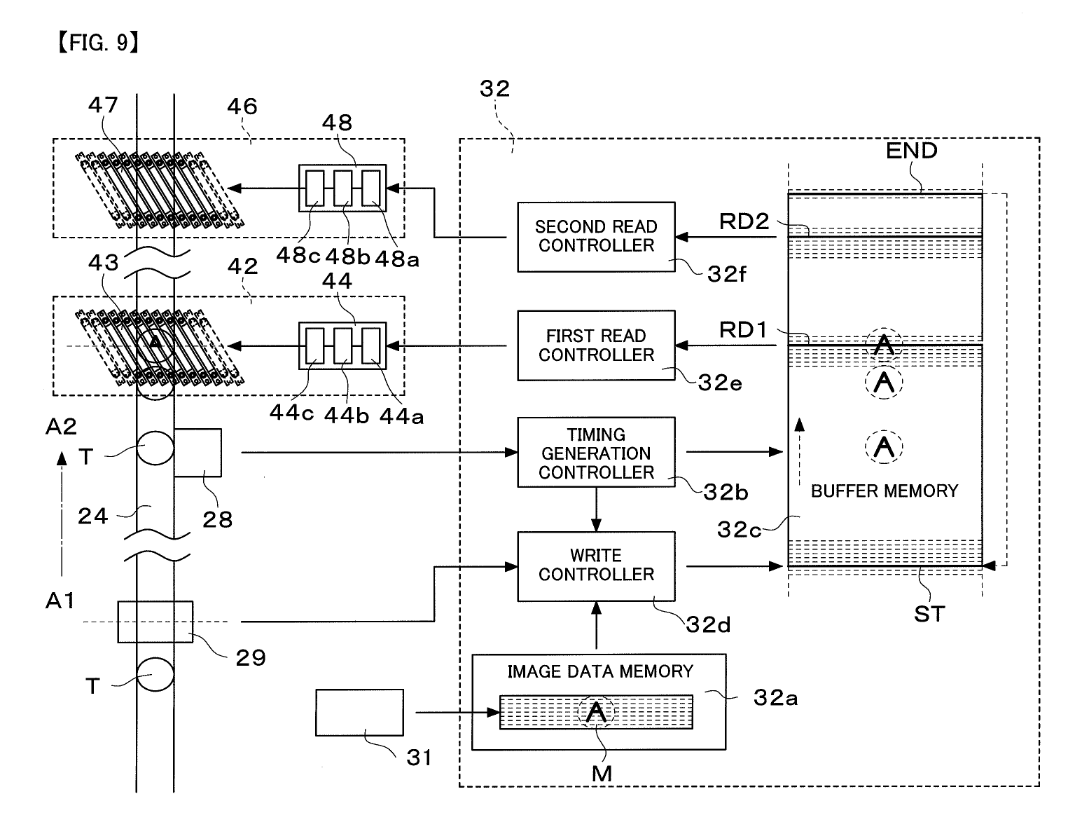

As shown in FIG. 9, the address shift of the master image M and the reading of the line data from the first read address RD1 are executed every time the pulse signal is output from the encoder 28, and the tablets T conveyed immediately below the printer heads 43 are sequentially subjected to printing. As a result, when the tablets T finish passing the printer heads 43, images of yellow and magenta in images of the master image M are finally printed onto the surface of each tablet T.

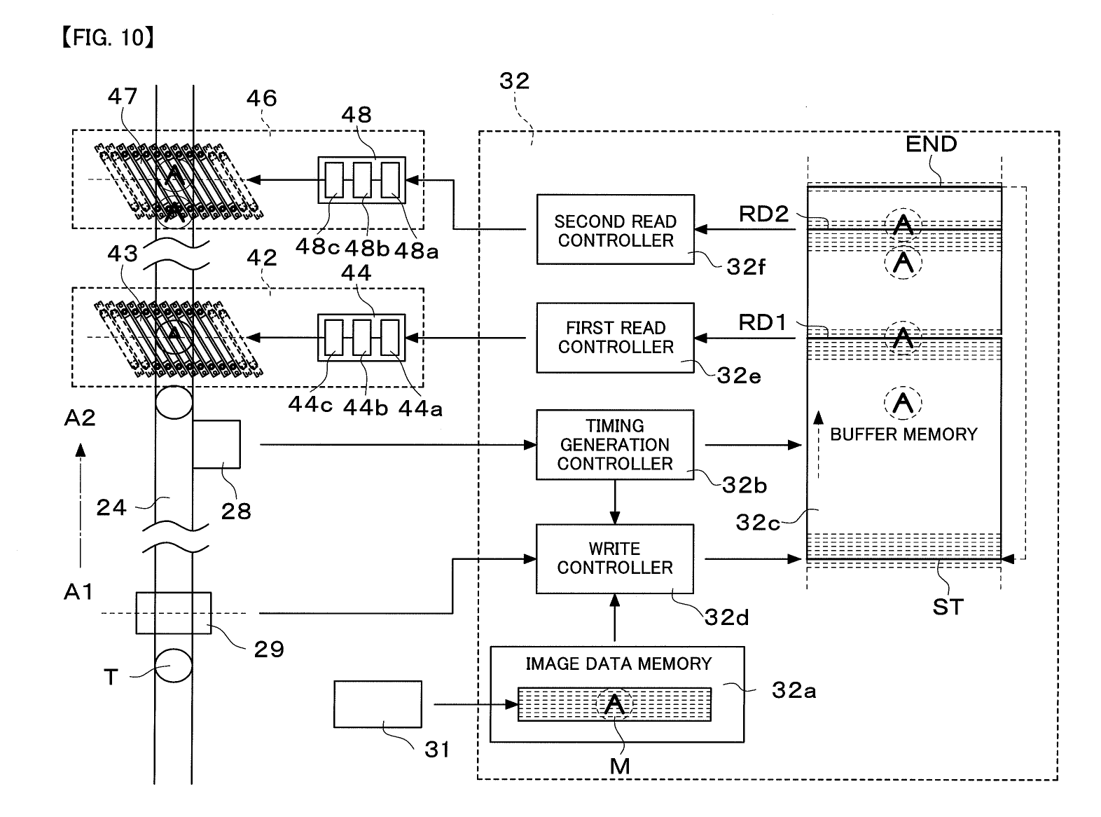

When the conveying belt 24 travels and the tablets T further moves, the line data stored in the buffer memory 32c is thereby subjected to the address shift and reaches the second read address RD2 as depicted in FIG. 10. The second read controller 32f reads the line data stored at the second read address RD2 and outputs it to the printer head control substrate 48 of the inkjet printer 46.

In the printer head control substrate 48, the line data of the master image M is temporarily stored in the storage section 48a and converted into color information of CMYK in the color converting section 48b, then the head output section 48c outputs cyan and black information to the printer heads 47, and ink discharge control is carried out. The printer heads 47 discharge the cyan ink and the black ink toward the tablets T based on cyan and black information supplied from the head output section 48c. As a result, images of cyan and black in the line data are printed onto the surface of each tablet T.

The master image M stored in the buffer memory 32c is subjected to the address shift in synchronization with the pulse signal from the encoder 28, and the data is erased when the master image M reaches the end address END.

As described above, in the inkjet printer 42, the yellow/magenta inks are discharged, and the yellow/magenta master image M is printed. In the subsequent inkjet printer 46 on the downstream side, the cyan/black inks are discharged at a timing further delayed from the discharge timing in the inkjet printer 42. As a result, on the downstream side, cyan/black images are printed onto the yellow/magenta images printed on the surface of each tablet T on the upstream side. Based on the above-described steps, polychromic printing using the four types of inks is carried out on the surface of each tablet T.

As explained above, the tablet detection signal is received from the tablet sensor 29 and, at the same time, the tablets conveyed at a high speed are subjected to printing in synchronization with the number of the pulse signals received from the encoder 28 provided to the conveying belt 24. That is, since the encoder 28 detects a moving distance of the conveying belt 24, a printing timing and others can be adjusted even if the movement of the conveying belt 24 is distorted, thereby enabling accurate printing just like an image.

Each tablet T after printing is further conveyed toward the downstream side by the conveying belt 24 and imaged by the printing section examination unit 51. The quality judgment unit 52 judges whether a print state of each tablet T is good based on imaging data, and the tablet T determined to have a printing defect as a result of the judgment is collected in a conveying route different from the regular route. Then, the polychromic printing with respect to each tablet T is terminated. Using the tablet printing apparatus 1 according to this embodiment enables printing on the tablets T at a high processing speed of 100000 pieces/hour.

A tablet printing apparatus according to another embodiment (a second embodiment) of the present invention will now be described.

Although the conveying path for the tablets T is provided in a single column in the tablet printing apparatus 1 according to the foregoing embodiment (the first embodiment), the tablet printing apparatus according to this embodiment is characterized in that conveying paths for the tablets T are provided in multiple columns and parallel print processing can be executed with respect to the plurality of tablets T.

This embodiment has substantially the same configuration as that of the tablet printing apparatus 1 according to the first embodiment, but it is partially different. The different configuration alone will be described hereinafter.

As shown in FIG. 11, in this embodiment, a plurality of belts 124a to 124c (i.e., conveying paths) are provided, and tablet sensors 129a to 129c are arranged with respect to the belts 124a to 124c, respectively.

It is to be noted that the belts 124a to 124c may be configured by simply providing the tablet conveying means 20 according to the first embodiment in parallel, or they may be configured by sharing other devices such as a case body 21 or a suction pump 27 and providing the plurality of belts alone in parallel.

On the other hand, in a unit control substrate 132, like the first embodiment, an image data memory 132a, a timing generation controller 132b, a buffer memory 132c, a write controller 132d, a first read controller 132e, and a second read controller 132f are provided.

The image data memory 132a stores master images M1 to M3 associated with the belts 124a to 124c.

The write controller 132d receives tablet detection signals from the tablet sensors 129a to 129c and controls writing the master images M1 to M3 into the buffer memory 132c. For example, upon receiving the tablet detection signal from the tablet sensor 129c, the write controller 132d reads the master image M3 in the image data memory 132a for one line and writes the read image at a start address ST in the buffer memory 132c. Then, line data in the buffer memory 132c is shifted toward an end address END in synchronization with a pulse signal input from the encoder 128, and the master image M3 is read in accordance with each line to be written at the start address ST.

When any other tablet sensor (e.g., the tablet sensor 129a) detects the tablets T while reading the master image M3 in accordance with each line to be written into the buffer memory 132c, write processing is executed in the following procedure.

First, when the write controller 132d receives the tablet detection signal, the write controller 132d reads the master image M2 associated with the tablet sensor 129a from the image data memory 132a. At the same time, the tablet sensor 129c has already detected the tablets T, and line data of the master image M3 has been read in accordance with each line.

The write controller 132d executes an OR arithmetic operation (a logical addition operation) with respect to the line data of the simultaneously read master images M2 and M3 to be combined, thereby creating image data (a combined master image). This combined master image is written at the start address ST of the buffer memory 132c. The combined master image is subjected to address shift in response to a pulse signal from the encoder 128 like the first embodiment, read out at a second read address RD1 by the first read controller 132e, and output to the printer head control substrate 144 of the inkjet printer 142. The printer head control substrate 144 drives and controls the printer heads 143 to print yellow and magenta images onto each tablet T.

Additionally, the combined master image is read out from the second read address RD2 by the second read controller 132f and output to the printer head control substrate 148 of the inkjet printer 146. The printer head control substrate 148 drives and controls the printer heads 147 to print cyan and black images onto each tablet T.

When the respective master images are combined to be stored in the buffer memory 132c in this manner, the buffer memory does not have to be provided in accordance with each conveying path, and the configuration of the tablet printing apparatus can be simplified.

It is to be noted that the example where the conveying paths are provided in three columns has been explained in this embodiment, any other conveying paths provided in multiple columns, e.g., two columns or four columns or more can be adopted.

The outline of the present invention is as described above. A modification of the present invention will now be described.

Although the four types of color inks are utilized to perform printing on the tablets T in each foregoing embodiment, a single-color printing apparatus that performs printing by using one color ink alone may be provided. In this case, when the apparatus is configured to include one of inkjet printers 42 and 46 alone and the number of ink discharged from this inkjet printer is one, the single-color printing can be realized.

Further, in case of the polychromic printing using two or more types of color inks, the present invention is not restricted to the apparatus using four types of inks like the foregoing embodiments. For example, two (e.g., yellow and cyan) in four types of colors inks alone may be used to perform printing.

Furthermore, although the inkjet printer 42 prints yellow/magenta images and the inkjet printer 46 prints cyan/black images in each of the foregoing embodiments, the types of colors discharged from each printer is not restricted those in such embodiments. For example, the inkjet printer 42 may discharge cyan.

Moreover, although one inkjet printer performs printing using two types of color inks in each embodiment, the present invention is not restricted to such embodiments. For example, as an embodiment, one inkjet printer may be provided for each color ink, or one inkjet printer may perform printing using three types of inks and the other inkjet printer may effect printing using the remaining one ink.

Additionally, although the line data of RGB is converted into the color information of CMYK by the printer head control substrate of the inkjet printer in the foregoing embodiments, the unit control substrate side may convert the RGB information into the color information of CMYK and output the color information to the printer head control substrate, and the printer head control substrate may carry out printing and output based on the output color information.

Further, although the ink tank shared by the respective inkjet printers is provided to supply the inks to the respective inkjet printers in the foregoing embodiment, it is possible to adopt a cartridge scheme that a plurality of ink cartridges accommodating respective color inks are inserted into the inkjet printers to be used.

### Examples

The present invention will be more specifically explained below with reference to examples, but this is just exemplification, and the scope of the present invention is not limited.

The same tablet printing apparatus was utilized with respect to three types of core tablets having different void ratios and different forming methods to perform printing under the same conditions.

As the tablet printing apparatus, an inkjet printer (manufactured by Mastermind, MMP813BT) was used. A black ink was adopted, and “H A” and “0.2” were written as print characters in two lines.

The core tablets as printing targets are the following three types.

A Celecox (registered trademark) tablet 100 mg (Astellas Pharma Inc): approximately 9.7% as a void ratio: a core tablet (a compressed tablet).

A Harnal (registered trademark) D tablet 0.2 mg (Astellas Pharma Inc): approximately 30% as a void ratio: an orally-disintegrating tablet (a compressed tablet).

A Zofran (registered trademark) Zydis (registered trademark) 4 mg (Glaxo Smith Kline): approximately 93% as a void ratio: an orally-disintegrating tablet (a template tablet).

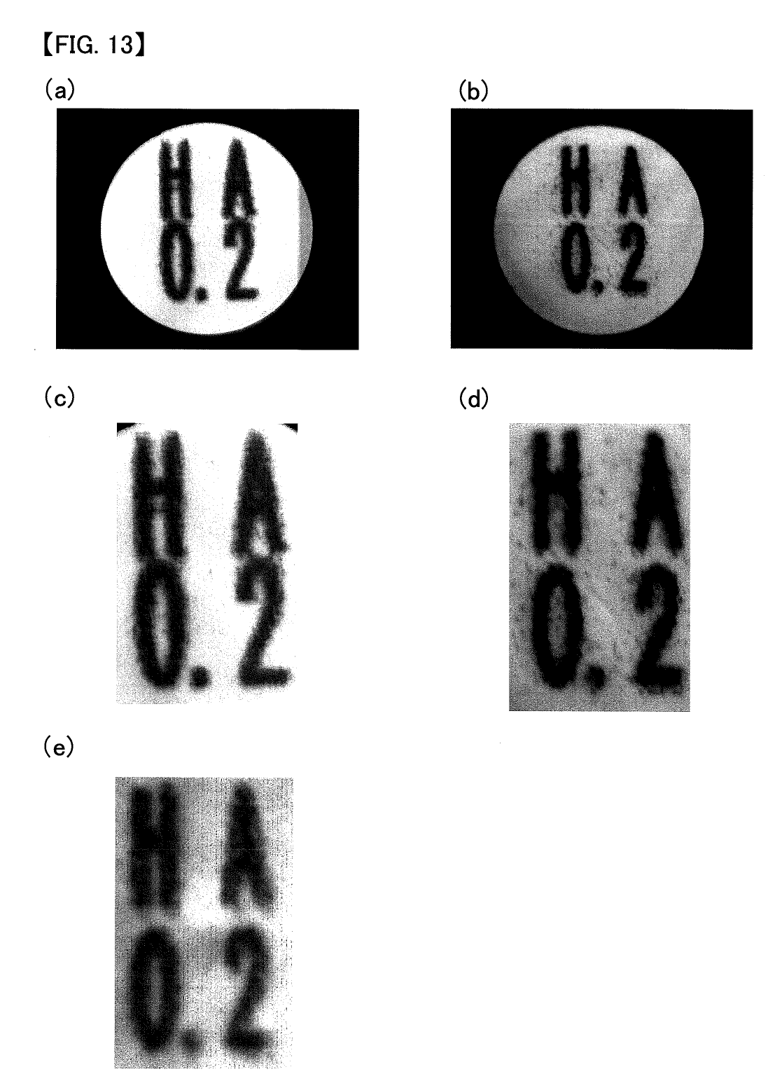

FIGS. 13(a) to (e) show printing results. FIG. 13(a) shows a photograph obtained by shooting the entire tablet after printing characters on the Celecox (registered trademark) tablet, FIG. 13(b) shows a photograph obtained by shooting the entire tablet after printing the characters on the Harnal (registered trademark) D tablet, FIG. 13(c) shows a magnified photograph of the print characters after printing the characters on the Celecox (registered trademark) tablet, FIG. 13(d) shows a magnified photograph of the print characters after printing the characters on the Harnal (registered trademark) D tablet, and FIG. 13(e) shows a magnified photograph of the print characters after printing the characters on the Zofran (registered trademark) Zydis (registered trademark), respectively.

It can be understood from the results shown in FIGS. 13(a) to (d) that the print characters were printed at a tablet central portion and protrusion to the outside of the tablet or a hiatus of the print characters did not occur in each of the Celecox (registered trademark) tablet and the Harnal (registered trademark) D tablet and clear printing was provided.

Further, as can be seen from the result shown in FIG. 13(e), the printing was also enabled in Zofran (registered trademark) Zydis (registered trademark) having a large void ratio, but the ink of the printed characters bled, and the printing was slightly unclear.

An influence of the void ratio with respect to definition of the printing was evaluated by comparing line widths of the characters printed under the above-described conditions. Table 1 shows results obtained by measuring a vertical line width and a lateral line width of a character “H” in the characters printed on each of the Celecox (registered trademark) tablet (Examples 1 and 2), the Harnal (registered trademark) D tablet (Examples 3 and 4), and Zofran (registered trademark) Zydis (registered trademark) (Examples 5 and 6).

TABLE 1

| | Example | Example | Example | Example | Example | Example |
|---|---|---|---|---|---|---|
| | 1 | 2 | 3 | 4 | 5 | 6 |
| VERTICAL | 0.40 mm | 0.38 mm | 0.43 mm | 0.46 mm | 0.60 mm | 0.63 mm |
| LINE | | | | | | |
| WIDTH OF | | | | | | |
| “H” | | | | | | |
| LATERAL | 0.39 mm | 0.38 mm | 0.40 mm | 0.39 mm | 0.52 mm | 0.51 mm |
| LINE | | | | | | |
| WIDTH OF | | | | | | |
| “H” | | | | | | |

As shown in Table 1, it was recognized that the Celecox (registered trademark) tablet having the void ratio of approximately 9.7% (Examples 1 and 2) and the Harnal (registered trademark) D tablet having the void ratio of approximately 30% (Examples 3 and 4) have narrower line widths and more clear print characters than Zofran (registered trademark) Zydis (registered trademark) having the void ratio of approximately 93%. That is, it can be considered that the ink is apt to bleed and the print characters become illegible as the void ratio is reduced.

It can be understood from this result that a smaller void ratio of a core tablet can provide desirable printing in terms of acquisition of a tablet having clear printing.

1. A tablet printing apparatus comprising:
tablet conveying means that has: a case body having an opening at an upper portion thereof; a slit plate arranged on the opening of the case body; a conveying path including a conveying belt that has a slit communicating with the inside of the case body formed between belts arranged in parallel along a slit of the slit plate and that conveys tablets; driving means for moving the conveying belt constituting the conveying path; and negative pressure means for forming a negative pressure in the case body, and that conveys the tablets in a moving direction in a state where the tablets are sucked and held on the conveying belt through both the slits by the negative pressure in the case body;
position detecting means for detecting positions of the tablets conveyed by the tablet conveying means on the conveying belt by using a tablet sensor that detects the tablets and an encoder that detects a moving state of the conveying belt irrespective of a moving speed of the conveying belt;
printing means for performing printing on the tablets conveyed by the tablet conveying means in a non-contact manner by using a plurality of printer heads that are arranged in parallel and fixed with respect to the tablet conveying means along a perpendicular direction of the moving direction of the tablets and have a plurality of nozzle holes for discharging inks being aligned in series at a slant with respect to the moving direction of the tablets; and
printing controlling means for controlling printing on the tablets performed by the printing means based on positions of the tablets on the conveying belt detected by the position detecting means.

2. The tablet printing apparatus according to claim 1, wherein the printing controlling means includes an image data memory that stores a master image to be printed on the tablets, a buffer memory that temporarily stores the master image, a write controller that writes the master image into the buffer memory, and a read controller that reads out the master image stored in the buffer memory,
the write controller write the master image into the buffer memory at a timing that the tablets are detected by the tablet sensor;
the buffer memory shifts an address at which the master image is stored in the buffer memory in synchronization with a pulse signal from the encoder, and
the read controller reads out the master image and outputs it for printing when the master image is stored at a predetermined read address.

3. The tablet printing apparatus according to claim 1, wherein the tablet conveying means has a plurality of conveying paths along which the tablets are conveyed,
the position detecting means detects moving positions of the tablets in the plurality of respective conveying paths, and
the printing controlling means controls a print timing provided by the printing means based on the moving positions of the tablets detected in the plurality of respective conveying paths by the position detecting means.

4. The tablet printing apparatus according to claim 1, wherein a plurality of nozzle hole groups including the plurality of nozzle holes are formed in the printer heads, and the plurality of nozzle hole groups discharge inks having different colors to enable printing in at least two colors.

5. The tablet printing apparatus according to claim 1, wherein the tablet is a core tablet.

6. The tablet printing apparatus according to claim 5, wherein the core tablet is an orally-disintegrating tablet.

7. The tablet printing apparatus according to claim 1, wherein the conveying belt moves at a speed falling within the range of 500 mm/second to 2000 mm/second.

8. A tablet printing apparatus comprising:
tablet conveying means that has: a case body having an opening at an upper portion thereof; a slit plate arranged on the opening of the case body; a conveying path including a conveying belt that has a slit communicating with the inside of the case body formed between belts arranged in parallel along a slit of the slit plate and that conveys tablets; driving means for moving the conveying belt constituting the conveying path; and negative pressure means for forming a negative pressure in the case body, and that conveys the tablets in a moving direction in a state where the tablets are sucked and held on the conveying belt through both the slits by the negative pressure in the case body;
position detecting means for detecting positions of the tablets conveyed by the tablet conveying means on the conveying belt by using a tablet sensor that detects the tablets and an encoder that detects a moving state of the conveying belt irrespective of a moving speed of the conveying belt;
printing means for performing printing on the tablets conveyed by the tablet conveying means in a non-contact manner by constituting each printer unit by using a plurality of printer heads that are arranged in parallel and fixed with respect to the tablet conveying means along a perpendicular direction of the moving direction of the tablets and have a plurality of nozzle holes for discharging inks being aligned in series at a slant with respect to the moving direction of the tablets and by providing the plurality of printer units at different positions along the moving direction of the tablets to discharge inks having different colors from the printer units; and
printing controlling means for controlling printing on the tablets performed by the printing means based on positions of the tablets on the conveying belt detected by the position detecting means.

9. A tablet production method for performing printing on many tablets irregularly conveyed by a conveying belt, comprising:
a tablet forming step of forming each tablet into a predetermined shape;
a tablet conveying step of conveying the tablets in a state where the formed tablets are held on the conveying belt;
a position detecting step of detecting positions of the tablets conveyed at the tablet conveying step on the conveying belt by using a tablet sensor that detects the tablets and an encoder that detects a moving state of the conveying belt irrespective of a moving speed of the conveying belt;
a printing controlling step of controlling printing on the tablets based on positions of the tablets on the conveying belt detected at the position detecting step; and
a printing step of performing printing on the tablets conveyed at the tablet conveying step in a non-contact manner by using a plurality of printer heads that are arranged in parallel and fixed along a perpendicular direction of the moving direction of the conveying belt and have a plurality of nozzle holes for discharging inks being aligned in series at a slant with respect to the moving direction of the tablet conveying belt.

10. A tablet subjected to printing by a tablet printing apparatus, the apparatus comprising:
a tablet formed into a predetermined shape;
tablet conveying means that has: a case body having an opening at an upper portion thereof; a slit plate arranged on the opening of the case body; a conveying path including a conveying belt that has a slit communicating with the inside of the case body formed between belts arranged in parallel along a slit of the slit plate and that conveys the tablets; driving means for moving the conveying belt constituting the conveying path; and negative pressure means for forming a negative pressure in the case body, and that conveys the tablets in a moving direction in a state where the tablets are sucked and held on the conveying belt through both the slits by the negative pressure in the case body;
position detecting means for detecting positions of the tablets conveyed by the tablet conveying means on the conveying belt by using a tablet sensor that detects the conveyed tablets and an encoder that detects a moving state of the conveying belt irrespective of a moving speed of the conveying belt;
printing means for performing printing on the tablets conveyed by the tablet conveying means in a non-contact manner by using a plurality of printer heads that are arranged in parallel and fixed with respect to the tablet conveying means along a perpendicular direction of the moving direction of the tablets and have a plurality of nozzle holes for discharging inks being aligned in series at a slant with respect to the moving direction of the tablets; and
printing controlling means for controlling printing on the tablets performed by the printing means based on positions of the tablets on the conveying belt detected by the position detecting means.

11. A tablet subjected to printing by a tablet printing method for performing printing on many tablets irregularly conveyed by a conveying belt, the method comprising:
a tablet forming step of forming each tablet into a predetermined shape;
a tablet conveying step of conveying the tablets in a state where the formed tablets are held on the conveying belt;
a position detecting step of detecting positions of the tablets conveyed at the tablet conveying step on the conveying belt by using a tablet sensor that detects the tablets and an encoder that detects a moving state of the conveying belt irrespective of a moving speed of the conveying belt;
a printing controlling step of controlling printing on the tablets based on positions of the tablets on the conveying belt detected at the position detecting step; and
a printing step of performing printing on the tablets conveyed at the tablet conveying step in a non-contact manner by using a plurality of printer heads that are arranged in parallel and fixed along a perpendicular direction of the moving direction of the conveying belt and have a plurality of nozzle holes for discharging inks being aligned in series at a slant with respect to the moving direction of the tablet conveying belt.

12. The tablet according to claim 10 or 11, wherein the tablet is a core tablet.

13. A tablet obtained by performing printing on a core tablet with inks having one or more colors.

14. The tablet according to claim 13, wherein the core tablet has a void ratio falling within the range of 5% to 40%.

15. The tablet according to claim 13, wherein the core tablet is obtained by performing compression forming with respect to a raw material containing active substances.

16. The tablet according to any one of claims 13 to 15, wherein the core tablet is an orally-disintegrating tablet.
